(19) United States
(12) Patent Application Publication
(10) Pub. No.: US 2012/0060517 A1
(43) Pub. Date: Mar. 15, 2012

(54) METHOD FOR SUPPLYING REFINED LIQUEFIED GAS

(75) Inventors: Hideharu Shimizu, Tsukuba (JP); Tadanobu Arimura, Tsukuba (JP)

(73) Assignee: TAIYO NIPPON SANSO CORPORATION, Tokyo (JP)

(21) Appl. No.: 13/320,821

(22) PCT Filed: May 13, 2010
(86) PCT No.: PCT/JP2010/003251

§ 371 Date: Nov. 16, 2011

(30) Foreign Application Priority Data
May 21, 2009 (JP) 2009-123069

(51) Int. Cl. F17C 7/04

(52) U.S. Cl. 62/48.1

(57) ABSTRACT

A method for supplying a refined liquefied gas, in which prior to the supply of a liquefied gas stored in a container, the liquefied gas is refined by (1) determining the concentrations of impurities in the gas phase, then estimating the concentration of each impurity in the liquid phase from the ratio between the liquid-phase concentration and the gas-phase concentration of the impurity (gas-liquid equilibrium constant (Kₙ)), and assuming the amount of the gas to be discharged from the gas phase part within the refinement tank to refine the liquefied gas, (2) discharging the gas from the gas phase part to refine the liquefied gas constituting the liquid phase, (3) sampling the gas phase and ascertaining the quality of the refined liquefied gas, and (4) supplying the refined liquefied gas to a receiver from the refinement tank.

### TECHNICAL FIELD

The present invention relates to a method for supplying a refined liquefied gas, comprising refining a raw material liquefied gas comprising one or more impurity component (s) having higher volatility than that of a liquefied gas that is a main component, which is stored in a refinement tank, and supplying the refined liquefied gas to a receiver.

### BACKGROUND ART

In general, high purity such as a purity of 99.999 (vol %) or more is required for a liquefied gas used for processes for the production of semiconductors, and the like, and in the past, refining operations in which impurities are removed by using multi-step rectification, various adsorbents or the like were implemented in liquefied gas-manufacturing facilities for refinement for increasing the purity of a liquefied gas. Furthermore, the use amount of a liquefied gas has increased in accordance with increase in the gauges of and increase in production amounts of wafers in recent years, which leads to, for example, progress in concentrated supply of ammonia liquefied gas containers that are used in semiconductor-manufacturing facilities from supply using conventional 25 Kg bombs or the like to supply using large containers such as 500 Kg containers and 1000 Kg containers.

Furthermore, since a vaporize amount may not catch up with a use amount in gas phase supply that utilizes the relatively high vapor pressure of a liquefied gas, it was suggested to address the use amount by maintaining the vapor pressure of a liquefied gas by heating a container as disclosed in Patent Literature 1, whereas supplying in the form of a gas (gaseous form) by vaporizing a liquefied gas in a vaporizer after passing through pipelines as a liquid has been implemented actively.

Meanwhile, since impurities included in a liquefied gas may affect various semiconductor-manufacture apparatuses and products in large amount and concentrated supply using large containers, removal of and control of the concentrations of impurities are extremely important problems. Therefore, liquefied gases are also refined by liquefied gas manufacturers so as to increase their purities.

When a liquefied gas is supplied as a gas (in a gaseous form), in principle, highly volatile impurities that are present unevenly in a gas phase at the initial stage of initiation of use from a container (oxygen gas, methane gas and the like in the case of liquefied ammonia) accompany the gas, and poorly volatile impurities (water in the case of liquefied ammonia) come to a liquid phase and concentrate therein when the residual amount of the liquefied gas in the container is decreased by the supply of the liquefied gas, which necessarily leads to a problem such as increase in the poorly volatile impurities in the supplied gas. In order to avoid such effect of impurity components, there is also an example in which an operation for decreasing impurities is implemented by disposing a gas refining means between a liquefied gas container in a receiver and a use point.

On the other hand, when a liquefied gas is supplied as a liquid (liquid form), the concentrations of highly volatile impurity components are lower than those in a gas phase in principle but the concentrations of poorly volatile impurity components become relatively high as compared to the supply in a gas; therefore, a refining means by removing moisture, for example, one disclosed in Patent Literature 2, for removing mainly poorly volatile impurities as in the case of the above-mentioned supply in a gas, is suggested.

### PRIOR ART DOCUMENTS

### Patent Literatures

Patent Literature 1: Japanese Patent Application Laid-Open No. 2007-032610
Patent Literature 2: Japanese Patent No. 4062710

### SUMMARY OF THE INVENTION

### Problem to be Solved by the Invention

As mentioned above, a rectification apparatus is generally used for the production of a high purity liquefied gas, but a rectification apparatus is generally large, the production cost thereof is high, and the operation thereof is complex. Furthermore, since processes at a low temperature are used, the energy cost for cooling rectification columns is also high. As a result, for example, a high purity ammonia gas is very expensive as compared to low purity industrial anhydrous ammonia.

Furthermore, also in the case when industrial anhydrous ammonia is rectified as a raw material in a use point of a semiconductor manufacturer, the above-mentioned increase in the production cost and energy cost in rectification, and complication of operations still remain as problems.

The present invention has been made in view of the above-mentioned problems of the conventional techniques, and the object thereof is to provide a method for supplying a refined liquefied gas comprising refining a raw material liquefied gas and supplying the refined liquefied gas to a receiver by convenient analysis means and refining operations using a convenient apparatus.

### Means for Solving the Problem

The present inventors have done intensive studies in view of the above-mentioned problems and consequently found that a liquefied gas refined with a high purity can be supplied to a receiver by measuring the concentration of a highly volatile impurity component in a gas phase in a container in which a raw material liquefied gas is stored, estimating the impurity component concentration in the liquid phase from said concentration and a gas-liquid equilibrium constant, and estimating the amount of the gas to be discharged from a gas phase part in the container necessary for refining the raw material liquefied gas, then implementing operations for refining the liquefied gas for discharging said amount of the gas to be discharged, followed by estimating the impurity component concentration in the liquid phase by measuring the impurity component concentration in the gas phase part in the container, and ascertaining the quality of the liquid phase part of the refined liquefied gas, and completed the present invention.

Namely, the gist of the present invention is as shown in the inventions described in the following [1] to [9].

[1] A method for supplying a refined liquefied gas, comprising

refining a raw material liquefied gas (R) that is stored in a refinement tank, or a raw material liquefied gas (R) that has been transferred from a storage container to the refinement tank, which comprises one or more impurity component(s) (Iₙ) having higher volatility than that of a liquefied gas that is a main component, by gas discharging from a gas phase part in the refinement tank, and supplying the refined liquefied gas (P) to a receiver, by implementing at least the following Operations 1 to 4:

<1> an operation (Operation 1) comprising collecting a sample from the gas phase part in the refinement tank in which the raw material liquefied gas (R) is kept at a constant temperature (t° C.) or constant pressure (pPa) and held in a gas-liquid equilibrium state, and measuring the concentration (C_{R}vₙ) of each impurity component (Iₙ) in the gas phase part, followed by estimating each impurity component concentration in the liquid phase (C_{R}lₙ in the refinement tank from the obtained each concentration (C_{R}vₙ) and the ratio between the liquid-phase concentration and the gas-phase concentration of each impurity component (gas-liquid equilibrium constant (Kₙ)) of each component at the constant temperature (t° C.) or constant pressure (pPa), according to the following formula (1), and

estimating the amount of the gas to be discharged (W) from the gas phase part in the refinement tank required for refining the raw material liquefied gas (R), by removing the highly volatile impurity component (Iₙ) that has concentrated in the gas phase part in the refinement tank and the impurity component (Iₙ) that comes from the liquid phase to the gas phase and concentrates therein when the liquefied gas in the liquid phase is vaporized in the refinement tank, from the respective concentrations ((C_{R}vₙ) and (C_{R}lₙ)) and the hold amounts of the impurity component in the gas phase and liquid phase,

Impurity component concentration in liquid phase (C_{R}lₙ)=Kₙ×impurity component concentration in gas phase (C_{R}vₙ) (1),

<2> an operation (Operation 2) comprising refining the liquefied gas in the liquid phase by removing the highly volatile impurity component (Iₙ) that has concentrated in the gas phase part and the impurity component (Iₙ) that comes from the liquid phase to the gas phase and concentrates therein by vaporizing the liquefied gas, by discharging continuously or intermittently the amount of the gas to be discharged (W) from the gas phase part in the refinement tank to a discharge passage,

<3> an operation (Operation 3) comprising measuring the concentration of each impurity component (Iₙ) of the sample collected from the gas phase part in the refinement tank that is kept at a constant temperature (t° C.) or constant pressure (pPa) and held in a gas-liquid equilibrium state in the discharging step, and/or after completion of the discharging, followed by estimating the concentration of the impurity component in the liquid phase (C_{P}lₙ) from the obtained each concentration (C_{P}vₙ) and the gas-liquid equilibrium constant (Kₙ), whereby ascertaining the quality of the refined liquefied gas (P), and

<4> an operation (Operation 4) comprising ascertaining the quality of the refined liquefied gas (P), followed by supplying the refined liquefied gas (P) from the refinement tank to the receiver through a supply passage.

[2] The method for supplying a refined liquefied gas according to [1] wherein

the Operation 2 comprises providing feedback of a detection signal of the impurity concentration in the gas phase part (C_{R}vₙ) measured by a gas chromatograph to a mass flow controller that is disposed on the discharge passage to control the aperture of the controller, or

the Operation 4 comprises providing feedback of a detection signal of the impurity concentration in the gas phase part (C_{P}vₙ) measured by a weight scale in the refinement tank or a gas chromatograph to a mass flow controller that is disposed on the supply passage to control the aperture of the controller.

[3] The method for supplying a refined liquefied gas according to [1] or [2], wherein the transfer of the raw material liquefied gas (R) from the storage container to the refinement tank in the Operation 1 is transfer of the raw material liquefied gas from which oil components have been removed to the refinement tank through an oil component separating apparatus.
[4] The method for supplying a refined liquefied gas according to any of [1] to [3], wherein the Operation 4 is an operation for supplying the refined liquefied gas (P) from the liquid phase part in the refinement tank to the receiver through a pressure reducing valve, a vaporizer and a moisture removing tube.
[5] The method for supplying a refined liquefied gas according to any of [1] to [3], wherein the Operation 4 is an operation for supplying the refined liquefied gas (P) from the liquid phase part in the refinement tank to the receiver through a pressure reducing valve, a vaporizer, a moisture removing tube and a metal removing filter.
[6] The method for supplying a refined liquefied gas according to any of [1] to [3], wherein the Operation 4 is an operation for supplying the refined liquefied gas (P) from the liquid phase part in the refinement tank to the receiver through an oil component separating apparatus, a pressure reducing valve, a vaporizer and a moisture removing tube.
[7] The method for supplying a refined liquefied gas according to any of [1] to [3], wherein the Operation 4 is an operation for supplying the refined liquefied gas (P) from the liquid phase part in the refinement tank to the receiver through an oil component separating apparatus, a pressure reducing valve, a vaporizer, a moisture removing tube and a metal removing filter.
[8] The method for supplying a refined liquefied gas according to any of [1] to [7], wherein the gas-liquid equilibrium constant (Kₙ) is an actually measured value Km that is obtained by collecting samples respectively from the liquid phase and the gas phase part that are held in a gas-liquid equilibrium state in the refinement tank in which the liquefied gas is stored at a constant temperature (t° C.) and performing quantitative analysis, or a calculated value Kc that is obtained from the Soave-Redlich-Kwong equation of state (SRK equation of state) and an exponent-type mixing rule that show the relationship between the amount of the impurity component included in the gas phase and the amount of the impurity component included in the liquid phase at a constant temperature (t° C.), from the physical property values including the critical temperature, critical pressure and polarizability of the impurity component.
[9] The method for supplying a refined liquefied gas according to any of [1] to [8], wherein the liquefied gas is liquefied ammonia, and the impurity component (s) in the liquid phase is/are at least methane and/or oxygen,

### Effect of the Invention

According to the method for supplying a refined liquefied gas of the present invention, a raw material liquefied gas (R) including much impurities (having a low purity) can be refined by convenient analysis means and refining operations by using a convenient apparatus, whereby a refined liquefied gas (P) whose quality has been ascertained can be supplied to a receiver.

### BRIEF DESCRIPTION OF THE DRAWINGS

FIG. 1 is an example of a flow in which the raw material liquefied gas (R) is transferred from the storage container to the refinement tank and refined therein, and the refined liquefied gas (P) is supplied to the receiver, in the method for supplying a refined liquefied gas of the present invention.

FIG. 2 is another example of a flow in which the raw material liquefied gas (R) is refined in the refinement tank, and the refined liquefied gas (P) is supplied to the receiver, in the method for supplying a refined liquefied gas of the present invention.

FIG. 3 is an explanatory drawing that shows the correspondence of the actually measured values and calculated values of the methane concentrations in the liquid phase and gas phase that are held in a gas-liquid equilibrium state in the liquefied ammonia container.

FIG. 4 is an explanatory drawing that shows the correspondence of the actually measured values and calculated values of the oxygen concentrations in the liquid phase and gas phase that are held in a gas-liquid equilibrium state in the liquefied ammonia container.

FIG. 5 is an explanatory drawing that shows the method for estimating the amount of the gas to be discharged when the purity of the liquefied gas in the liquid phase is increased by discharging the gas from the gas phase part of the liquefied gas in the container.

FIG. 6 is a drawing that shows the relationship between the amount of the gas to be discharged from the gas phase part of the liquefied ammonia stored in the refinement tank, and decrease in the methane concentrations in the gas phase and liquid phase.

FIG. 7 is a drawing that shows the relationship between the amount of the gas to be discharged from the gas phase part of the liquefied ammonia stored in the refinement tank and decrease in the oxygen concentrations in the gas phase and liquid phase.

### MODES FOR CARRYING OUT THE INVENTION

Hereinafter the “method for supplying a refined liquefied gas” of the present invention is explained.

The method for supplying a refined liquefied gas of the present invention comprises refining a raw material liquefied gas (R) that is stored in a refinement tank, or a raw material liquefied gas (R) that has been transferred from a storage container to the refinement tank, which comprises one or more impurity components) (Iₙ) having higher volatility than that of a liquefied gas that is a main component, by gas discharging from a gas phase part in the refinement tank, and supplying the refined liquefied gas (P) to a receiver, by implementing at least the following Operations 1 to 4:

<1> an operation (Operation 1) comprising collecting a sample from the gas phase part in the refinement tank in which the raw material liquefied gas (R) is kept at a constant temperature (t° C.) or constant pressure (pPa (Pascal)) and held in a gas-liquid equilibrium state, and measuring the concentration (C_{R}vₙ) of each impurity component (Iₙ) in the gas phase part, followed by estimating each impurity component concentration in the liquid phase (C_{R}lₐ) in the refinement tank from the obtained each concentration (C_{R}vₙ) and the ratio between the liquid-phase concentration and the gas-phase concentration of each impurity component (gas-liquid equilibrium constant (Kₙ)) of each component at the above-mentioned constant temperature (t° C.) or constant pressure (pPa), according to the following formula (1), and

estimating the amount of the gas to be discharged (W) from the gas phase part in the refinement tank required for refining the raw material liquefied gas (R), by removing the highly volatile impurity component (Iₙ) that has concentrated in the gas phase part in the refinement tank and the impurity component (Iₙ) that comes from the liquid phase to the gas phase and concentrates therein when the liquefied gas in the liquid phase is vaporized in the refinement tank, from the concentrations ((C_{R}vₙ) and (C_{R}lₙ)) and the hold amounts of the impurity component in the gas phase and liquid phase, respectively,

Impurity component concentration in liquid phase (C_{R}lₙ)=Kₙ×impurity component concentration in gas phase (C_{R}vₙ) (1),

<2> an operation (Operation 2) comprising refining the liquefied gas in the liquid phase by removing the highly volatile impurity component (Iₙ) that has concentrated in the gas phase part and the impurity component (Iₙ) that comes from the liquid phase to the gas phase and concentrates therein by vaporizing the liquefied gas, by discharging continuously or intermittently the above-mentioned amount of the gas to be discharged (W) from the gas phase part in the refinement tank to a discharge passage,

<3> an operation (Operation 3) comprising measuring the concentration of each impurity component (Iₙ) of the sample collected from the gas phase part in the refinement tank that is kept at a constant temperature (t° C.) or constant pressure (pPa) and held in a gas-liquid equilibrium state in the above-mentioned discharging step, and/or after completion of the discharging, followed by estimating the concentration of the impurity component in the liquid phase (C_{P}lₙ) from the obtained each concentration (C_{P}vₙ) and the gas-liquid equilibrium constant (Kₙ), whereby ascertaining the quality of the refined liquefied gas (P), and

<4> an operation (Operation 4) comprising ascertaining the quality of the above-mentioned refined liquefied gas (P), followed by supplying the refined liquefied gas (P) from the refinement tank to the receiver through a supply passage.

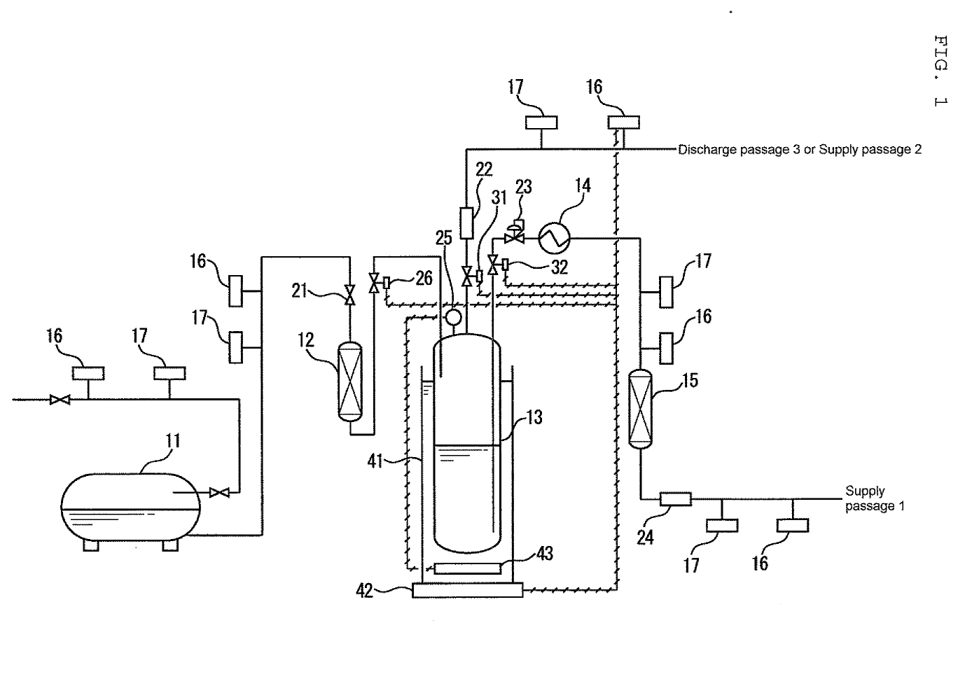

FIG. 1 is an example of the flow of the “method for supplying a refined liquefied gas” of the present invention (hereinafter sometimes referred to as the first embodiment). In FIG. 1, only a necessary amount of a raw material liquefied gas (R) is transferred to a refinement tank (13) from a storage container (11) to the refinement tank (13) through a liquid phase ejection valve (21), or from the storage container (11) to the refinement tank (13) through the liquid phase ejection valve (21) and an oil separation apparatus (12). After the transfer, after reaching a gas-liquid equilibrium state at a constant temperature, the liquefied gas is passed through a discharge passage 3, the impurity component concentration in the gas phase part (Cvₙ) in the refinement tank (13) is analyzed by a gas chromatograph (16) disposed on the discharge passage 3, and the impurity component concentration in the liquid phase (Clₙ), is estimated from the impurity component concentration (Cvₙ) and a gas-liquid equilibrium constant.

Next, the amount of the gas to be discharged (W) from the gas phase part in the refinement tank necessary for refining the liquefied gas is estimated by removing the highly volatile impurity component (Iₙ) that has concentrated in the gas phase part in the refinement tank and the impurity component (Iₙ) that comes from the liquid phase to the gas phase and concentrates therein when the liquefied gas in the liquid phase is vaporized in the refinement tank. Thereafter, an operation for refining including discharging the gas in which the impurity component (Iₙ) has come from the gas phase part in the refinement tank and concentrated therein by the above-mentioned amount to be discharged (W) from the discharge passage 3 while maintaining the liquefied gas in the refinement tank at the above-mentioned constant temperature. The amount to be discharged (W) can be ascertained by, for example, a weight scale (42) as shown in FIG. 1, or the like. During the period of discharging of the gas, in order to keep the inside of the refinement tank at an approximately constant temperature, for example, as shown in FIG. 1, a means such as disposing a refinement tank (41) in a thermostatic bath (41) in which a heater (43) has been disposed can be adopted.

Next, the quality of the refined liquefied gas is ascertained by measuring the impurity component concentration in the gas phase part (Cvₙ) in the refinement tank, and estimating the impurity component concentration in the liquid phase (Clₙ) in a manner similar to that mentioned above. After the quality of the refined liquefied gas is ascertained, the refined liquefied gas (P) that has been refined from the liquid phase part in the refinement tank (13) is supplied from a supply passage 1 to a receiver through a pressure reducing valve (23), a vaporizer (14), a moisture removing tube (15) for removing moisture and a mass flow controller (24). In addition, in the first embodiment, it is also possible to supply the liquefied gas that has been vaporized from the gas phase part in the refinement tank (13), from a supply passage 2 to the receiver through a mass flow controller (22) after completion of the refining operations.

Various dispositions of the pressure reducing valve and vaporizer are known, and there are a format in which vaporization is carried out after reducing the pressure and a format in which the pressure is reduced after vaporization, and the order of the pressure reducing valve and vaporizer is not specifically limited in the present invention.

Furthermore, in the example of the flow shown in FIG. 1, a gas chromatograph (16) and a moisture scale (17) can be disposed on the positions shown in FIG. 1 as necessary so that the impurity component of the liquefied gas in the raw material liquefied gas (R), refined liquefied gas (P) and the intermediate steps can be analyzed.

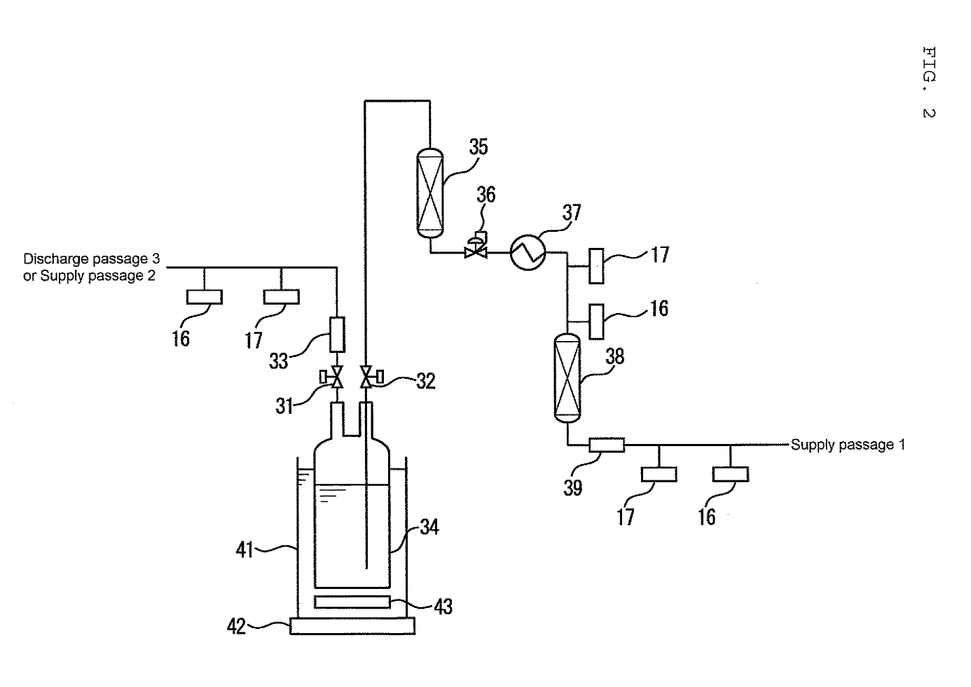

FIG. 2 is another example of a flow of the “method for supplying a refined liquefied gas” of the present invention (hereinafter sometimes referred to as the second embodiment). Similarly to the case of the above-mentioned refinement tank (13), after a raw material liquefied gas (R) in a refinement tank (34) reaches a gas-liquid equilibrium state at a constant temperature, the gas is passed through a discharge passage 3 and the like of a refinement tank (34), the impurity component concentration in the gas phase part (Cvₙ) in the refinement tank (34) is analyzed by a gas chromatograph (16), and the impurity component concentration in the liquid phase (Clₙ) is estimated from the impurity component concentration (Cvₙ) and a gas-liquid equilibrium constant. Next, the amount of the gas to be discharged (W) from the gas phase part in the refinement tank necessary for refining the raw material liquefied gas (R) is estimated by removing the highly volatile impurity component (Iₙ) that has concentrated in the gas phase part in the refinement tank and the impurity component (Iₙ) that comes from the liquid phase to the gas phase and concentrates therein when the liquefied gas in the liquid phase is vaporized in the refinement tank.

An operation for refining, including discharging the gas in which the impurity component (Iₙ) has come from the gas phase part in the refinement tank and concentrated in the gas, from the discharge passage 3 by the above-mentioned discharge amount (W) while maintaining the liquefied gas in the refinement tank at the above-mentioned constant temperature, is implemented. The amount to be discharged (W) can be ascertained by, for example, a weight scale (42) as shown in FIG. 2, or the like. During the period of discharging of the gas, in order to keep the inside of the refinement tank at an approximately constant temperature, for example, as shown in FIG. 2, a means such as disposing the refinement tank (34) in a thermostatic bath (41) in which a heater (43) has been disposed can be adopted.

Next, the quality of the refined liquefied gas is ascertained by measuring the impurity component concentration in the gas phase (Cvₙ) by the gas chromatograph (16) disposed on the discharge passage 3, and the like, and estimating the impurity component concentration in the liquid phase (Clₙ) in a manner similar to that mentioned above. After the quality of the refined liquefied gas is ascertained, the refined liquefied gas (P) that has been refined from the liquid phase part in the refinement tank (34) is supplied from the supply passage 1 to a receiver through a liquid phase ejection valve (32), an oil component separating apparatus (35), a pressure reducing valve (36) and a vaporizer (37), and through a moisture removing tube (38) for removing moisture and a mass flow controller (39). In addition, also in the second embodiment, it is also possible to supply the liquefied gas that has been vaporized from the gas phase part in the refinement tank (34) from a supply passage 2 to the receiver through a gas phase ejection valve (32) and mass flow controller (33) after completion of the refining operations.

In FIG. 2, the raw material liquefied gas (R) to the refinement tank (34) can be supplied from the upper stream side of the gas phase ejection valve (31), or from the downstream side of the liquid phase ejection valve (32).

Furthermore, also in the example of the flow shown in FIG. 2, similarly to the case of FIG. 1, the gas chromatograph (16) and a moisture scale (17) can be disposed on the positions shown in FIG. 2 as necessary so that the impurity components in the liquefied gas can be analyzed in the raw material liquefied gas (R), the refined liquefied gas (P), and a liquefied gas in the intermediate steps.

### [1] Raw Material Liquefied Gas (R) and Impurity Component (Iₙ)

As the raw material liquefied gas (R) that can be applied to the method for supplying a refined liquefied gas of the present invention, liquefied ammonia, chlorine, boron trichloride, hydrogen selenide, propane and the like, which can be used for processes for the production of semiconductors, can be exemplified. Furthermore, the impurity component (Iₙ) differs depending on the production process and the like of each raw material liquefied gas (R).

### (1) Liquefied Ammonia

Ammonia is a gas that is colorless at an ordinary temperature and a normal pressure and has a boiling point of −33.34° C. and a characteristic irritating odor. Generally, industrial liquefied ammonia that is produced from natural gas, naphtha or the like by water vapor modification includes methane, nitrogen, hydrogen, carbon dioxide and carbon monoxide as impurity components (Iₙ) that volatilize more easily than the ammonia does, and also includes water as a poorly volatile impurity component.

Of these impurity components, those should be removed in practical use or in industry are generally methane and oxygen that are highly volatile components, and water that is a poorly volatile component.

### (2) Liquefied Chlorine (Cl₂)

Chlorine has a boiling point of −34.1° C., and is used for etching and the like in the field of semiconductors.

An industrial liquefied chlorine gas includes, for example, oxygen, hydrogen and the like as highly volatile trace amount of impurity components.

### (3) Liquefied Boron Trichloride (BCl₃)

Boron trichloride has a boiling point of 12.5° C., and is used for dry etching of aluminum wirings for semiconductors, liquid crystals and the like. Industrial liquefied boron trichloride includes, for example, oxygen and chlorine as highly volatile trace amount of impurity components.

### (4) Liquefied Hydrogen Selenide (H₂Se)

Hydrogen selenide has a boiling point of −41.2° C., and is used for semiconductors.

Industrial liquefied hydrogen selenide includes, for example, hydrogen as a trace amount of highly volatile impurity component.

### (5) Liquefied Propane

High purity propane gains attention in recent years as a raw material for the production of carbonized silicon devices that are promising materials for power semiconductor devices. A liquefied propane gas for industries or general fuels generally includes a large amount of hydrocarbons having 1 to 2 carbon atoms as highly volatile impurity components.

In the liquefied gas and the like as exemplified in the above-mentioned (1) to (5), the liquefied gas that has been refined by gas discharging of the liquefied gas including impurity components that are more highly volatile than the liquefied gas in the liquid phase, which is stored in the refinement tank, from the gas phase part in the refinement tank, can be suitably utilized for semiconductor-manufacturing apparatuses as a high purity semiconductor material gas.

### [2] Refinement Tank

The refinement tank (13) and refinement tank (34) are containers that are used for the purpose of obtaining the refined liquefied gas (P) by decreasing the impurity component concentration (Iₙ) in the raw material liquefied gas (R), and also used as stock point-like storage containers for the raw material liquefied gas (R), and FIG. 1 shows an example of the conceptual diagram of the refinement tank (13), and FIG. 2 shows an example of the conceptual diagram of the refinement tank (34). Specifically, the refinement tank (13) can be used in a similar manner to that of bombs that are widely distributed in the markets.

It is desirable that the refinement tank (13) and the refinement tank (34) are provided with constant-temperature equipments such as heating and/or cooling means, or are disposed in a thermostatic bath (41), so that the impurity component concentration in the gas phase that is held in a gas-liquid equilibrium state at a constant temperature can be analyzed and the impurity component in the liquid phase can be estimated from the gas-liquid equilibrium constant at the temperature. Meanwhile, the storage container (11) is a container that stores the raw material liquefied gas (R) of a relatively large volume.

[3] Transfer of Raw Material Liquefied Gas (R) from Storage Container to Refinement Tank

As shown in FIG. 1, the raw material liquefied gas (R) in the refinement tank (13) in the first embodiment is received from the storage container (11). In the first embodiment, in order to produce the refined liquefied gas (P) that conforms with a quality standard, only a necessary amount of the raw material liquefied gas (R) is stored once in the refinement tank (13) from the large-sized storage container (11) in which the raw material liquefied gas (R) is stored, and the raw material liquefied gas (R) is refined in the refinement tank (13) so as to conform with a desired quality standard.

Meanwhile, in the case when the raw material liquefied gas (R) includes an oil component that needs to be removed as an impurity component, the oil component can be removed by disposing an oil component removing apparatus (12) as shown in FIG. 1 and receiving the oil component through the oil component removing apparatus (12). An example of the oil component removing means include, for example, filling active carbon in the oil component removing apparatus (12).

The second embodiment is similar to the first embodiment except that the raw material liquefied gas (R) is directly supplied to the refinement tank (34) without passing through the oil component removing apparatus (12) as shown in the flow exemplified in FIG. 2. Meanwhile, the supply may be directly received by the refinement tank (34) from the production plant, or may be received from a tanker lorry or the like, and such supply source is not specifically limited. Furthermore, as shown in FIG. 1, during the reception of the raw material liquefied gas (R) into the refinement tank (13), the opening and closing of a liquid phase receiving valve (26) can be controlled by a signal from a weight scale (42) that measures the weight of the refinement tank (13).

### [4] Operations 1 to 4

Hereinafter Operations 1 to 4 are explained.

### [4-1] Operation 1

Operation 1 is an operation comprising collecting a sample from the gas phase part in the refinement tank in which the raw material liquefied gas (R) is kept at a constant temperature (t° C.) or constant pressure (pPa) and held in a gas-liquid equilibrium state, and measuring the concentration (C_{R}vₙ) of each impurity component (Iₙ) in the gas phase part, followed by estimating each impurity component concentration in the liquid phase (C_{R}lₙ) in the refinement tank from the obtained each concentration (C_{R}vₙ) and the ratio between the liquid-phase concentration and the gas-phase concentration of each impurity component (gas-liquid equilibrium constant (Kₙ)) of each component at the above-mentioned constant temperature (t° C.) or constant pressure (pPa), according to the following formula (1), and estimating the amount of the gas to be discharged (W) from the gas phase part in the refinement tank required for refining the raw material liquefied gas (R), by removing the highly volatile impurity component (Iₙ) that has concentrated in the gas phase part in the refinement tank and the impurity component (Iₙ) that comes from the liquid phase to the gas phase and concentrates therein when the liquefied gas in the liquid phase is vaporized in the refinement tank, from the respective concentrations ((C_{R}v) and (C_{R}lₙ)) and the hold amounts of the impurity component in the gas phase and liquid phase.

Impurity component concentration in liquid phase (C_{R}lₙ)=Kₙ×impurity component concentration in gas phase (C_{R}vₙ) (1).

Meanwhile, in a liquefied gas, the pressure in the refinement tank, i.e., the vapor pressure is unambiguously determined by the temperature of the liquefied gas, and thus temperature control and pressure control are implemented at the same time.

Hereinafter the impurity component concentration in the gas phase of the liquefied gas in the container is sometimes referred to as an impurity component concentration (Cvₙ), and the impurity component concentration in the liquid phase of the liquefied gas in the container is sometimes referred to as an impurity component concentration (Clₙ), irrespective of the raw material liquefied gas (R) or refined liquefied gas (P).

(1) Estimation of Each Impurity Component Concentration in Liquid Phase (Clₙ) from Each Impurity Component Concentration in Gas Phase (Cvₙ) and Gas-Liquid Equilibrium Constant (Kₙ)

### (1-1) Measurement of Impurity Concentration in Gas Phase (Cvₙ) and Impurity Concentration in Liquid Phase (Clₙ) in Refinement Tank

When a sample for measurement is collected from the gas phase part of the refinement tank (13 or 34) in which the liquefied gas is stored, it is preferable that the inside of the refinement tank is kept for a predetermined time (for example, at least 1 hour) until the temperatures of the liquid phase part and gas phase part become approximately a constant temperature so that the liquid phase part and gas phase part are held in a gas-liquid equilibrium state at a constant temperature (for example, 25° C.).

The collection of the sample for measurement from the gas phase part of the refinement tank (13 or 34) needs to be implemented under a condition at which a part of the collected sample is not liquefied, by adjusting the temperature for the collection circumstance to an atmosphere at a temperature equal to or more than the above-mentioned container temperature. The same applies to the temperature for the measurement circumstance.

Each impurity component concentration in the gas phase (Cvₙ) can be measured by using a gas chromatograph. As the gas chromatograph, for example, format: a gas chromatograph with a pulse discharge detector manufactured by GL Science (hereinafter the “gas chromatograph with a pulse discharge detector” is sometimes referred to as GC-PDD) can be used, or a measurement can also be implemented in a similar manner by using a gas chromatograph with a hydrogen flame ionization detector (hereinafter sometimes referred to as GC-FID).

Meanwhile, the impurity concentration in the liquid phase (Clₙ) can be measured by collecting a sample from the liquid phase in each of the above-mentioned containers, and vaporizing and homogenizing the liquid phase by a vaporizer, and using the above-mentioned GC-PDD, GC-FID or the like.

### (1-2) Gas-Liquid Equilibrium Constant (Kₙ)

The gas-liquid equilibrium constant (Kₙ) is calculated from the above-mentioned formula (1) from (the impurity component concentration in the liquid phase (Clₙ)/the impurity component concentration in the gas phase (Cvₙ)).

When the raw material liquefied gas (R) includes a plurality of one or more impurity components (I₁, I₂, I₃, . . . ) that are more highly volatile than the liquefied gas, the concentrations of the impurity components (Cv₁, Cv₂, Cv₃, . . . ) in the gas phase that is held in a gas-liquid equilibrium state at a constant temperature in the refinement tank are measured, thereafter the respective concentrations of these impurity components (Cl₁, Cl₂, Cl₃, . . . ) in the liquid phase that is held in a gas-liquid equilibrium state in the refinement tank can be estimated by the following formula (2) from the respective ratios of the liquid phase concentrations and gas phase concentrations of these impurity components (gas-liquid equilibrium constants K₁, K₂, K₃, . . . ) at the above-mentioned temperature by the above-mentioned formula (1).

Cl₁=K₁×Cv₁, Cl₂=K₂×Cv₂, Cl₃=K₃×Cv₃, . . . (2)

Such gas-liquid equilibrium constant (Kₙ) can be obtained respectively from an actually measured values and a calculated values from the theoretical formula, which are mentioned below. Hereinafter a gas-liquid equilibrium constant obtained from an actually measured value is sometimes referred to as Km, and the gas-liquid equilibrium constant obtained by calculation from the theoretical formula is sometimes referred to as Kc.

### (1-2-1) Means for Obtaining Actually Measured Value Km of Gas-Liquid Equilibrium Constant

For an objective substance that is held in a gas-liquid equilibrium state at a constant temperature, the impurity component concentration in the liquid phase (Clₙ) and the impurity component concentration in the gas phase (Cvₙ) are measured plural times to prepare gas-liquid equilibrium data, and Km can be determined for each data. Furthermore, data based on experiments can also be collected from literatures, collective data and the like without measuring on a case-by-case basis.

The gas-liquid equilibrium data is data of an equilibrium state between a gas phase and a liquid phase in a mixture, refers to a temperature, a pressure, a gas phase composition and a liquid phase composition, and is a kind of phase equilibrium data.

### (1-2-2) Means for Obtaining Calculated Value Kc of Gas-Liquid Equilibrium Constant

For the relationship between the amount of the impurity component included in the gas phase and the amount of the impurity component included in the liquid phase at a constant temperature (t° C.), the Soave-Redlich-Kwong equation of state (SRK equation of state), the BWR equation of state or the like can be used as an equation of state; it is necessary to apply a mixing rule to a system consisting of a plurality of components, and an exponent-type mixing rule, a simplified mixing rule, the PSRK mixing rule or the like can be used as the mixing rule, and the combination of the equation of state and mixing rule is not specifically limited.

In practical use, a method for obtaining a calculated value Kc of a gas-liquid equilibrium constant by using the SRK equation of state and the exponent-type mixing rule is preferable in a mixed system. Hereinafter the method is explained.

In addition, the SRK equation of state and exponent-type mixing rule are explained in the following Non-patent Literatures 1 to 4, respectively.
(a) Non-patent Literature 1 (a literature about equations of state)

Hiroshi Takamatsu and other one person, “The reports of Institute of Advanced Material Study, Interdisciplinary Graduate School of Engineering Sciences, Kyushu University”, Vol. 4, No. 1, 1990, p. 39-46
(b) Non-patent Literature 2 (a literature about the exponent-type mixing rule)

Shigetoshi Obuchi and other two persons, “Separation Technology”, Vol. 38, No. 6, 2008, p. 387-393
(c) Non-patent Literature 3 (a literature about equations of state)

Sandarusi et al. “Ind. Eng. Chem. Process. Des. Dev.”, 25, 1986 P. 957-963
(d) Non-patent Literature 4 (a literature about the exponent-type mixing rule)

Haruki. M et al. “J. Chem. Eng. Jpn.”, 32, 1999 P. 535-539

Hereinafter the means for obtaining a calculated value Kc of a gas-liquid equilibrium constant is described.

For a component system whose gas-liquid equilibrium data is not published by a known literature or collective data, Kc can be obtained by a calculation based on a theory of physics, chemistry, physical chemistry or the like.

Furthermore, there are not only cases in which all are estimated theoretically, but also methods for calculating a semi-theoretical value by using an actually measured value. Examples of such methods may include, for example, group contribution methods such as UNIFAC, methods for determining parameters in the equation of state from experimental values, and the like.

The estimation of physical properties of a mixture using the equation of state can be implemented by a calculation of phase equilibrium (gas-liquid equilibrium) based on the equation of state and the mixing rule. In this case, the critical constant, vapor pressure, parameters of heterogeneous interaction between molecules and the like of each single substance are necessary. It is generally known that such parameters of heterogeneous interaction between molecules can represent gas-liquid equilibrium data with considerable accuracy as existential parameters, and are useful.

In the case when a calculated value Kc of a gas-liquid equilibrium constant is theoretically estimated, estimation with more improved accuracy is enabled by using once gas-liquid equilibrium data based on an actual measurement when determining the above-mentioned parameter of heterogeneous interaction between molecules.

[i] Method in which Exponent-Type Mixing Rule is Applied to SRK Equation of State

Hereinafter a means for obtaining a calculated value Kc of an equilibrium constant is explained when the SRK equation of state is used as an equation of state and the exponent-type mixing rule is used as a mixing rule.

Since the SRK equation of state is represented by the following formula (3) (see Non-patent Literature 1, page 40) and based on the three-variant corresponding state principle, physical property values can be calculated by giving T_{c}, P_{c} and ω.

P=[RT/(v−b)]+[a/(v(v+b))] (3)

In the above-mentioned formula, P is a pressure (atm), R is a general gas constant (atm·l/(mol·K)), T is an absolute temperature (K) and v is a molar volume (l/mol).

In the above-mentioned formula, a is a coefficient of an attractive term and b is an excluded volume of the Readlich-Kwong formula (RK formula), and these values can be obtained from the following formula in the case of a pure substance. Meanwhile, a_{c} is the temperature correction coefficient of an energy parameter α, T_{c} is a critical temperature, P_{c} is a critical pressure, ω is an eccentric coefficient that shows deviation of a molecule from a spherical molecule, and Ωₐ and Ω_{b} are numerical values that are given by the conditions of a critical point.

a and b may be constants, or functions depending on a temperature and a substance.

$$[ Mathematical Formula 1 ]$$

$$When$$

$$a = {Ω}_{a} \frac{{R}^{2} {T}_{c}^{2}}{{P}_{c}} α ( T ) ≡ {a}_{c} α ( T ) , \\ α ( T ) = {( 1 + κ ( 1 - \sqrt{\frac{T}{{T}_{c}}} ) )}^{2}$$

$$b = {Ω}_{b} \frac{{RT}_{c}}{{P}_{c}}$$

provided that

### K=0.48+1.574ω−0.176ω²

Ωₐ=0.4274802327
Ω_{b}=0.086640350

On the other hand, in the case of a mixed system, it is necessary to adopt a mixing rule, and when an exponent-type mixing rule is used as a mixing rule, a and b are represented by the following formulas (4), (5) and the like, respectively.

$$\begin{matrix}[ Mathematical Formula 2 ] & \\ a = {\sum }_{i , j = 1}^{n} {x}_{i} {x}_{j} {a}_{ij} \\ {a}_{ij} = ( 1 - {k}_{ij} ) \sqrt{{a}_{i} {a}_{j}} ( i \neq j ) \\ {a}_{i} = {a}_{ci} {α}_{i} ( T ) & ( 4 ) \\ b = {\sum }_{i , j = 1}^{n} {( {x}_{i} {x}_{j} )}^{β} {b}_{ij} \\ {b}_{ij} = ( 1 - {l}_{ij} ) \frac{{b}_{i} + {b}_{j}}{2} \\ {b}_{i} = {Ω}_{b} \frac{{RT}_{ci}}{{P}_{ci}} & ( 5 )\end{matrix}$$

The subscript i or j mean respective components, and n is the maximum number of the components.

xᵢ and xⱼ are parameters that represent the concentrations of the components i and j, kᵢⱼ, lᵢⱼ and β are parameters that represent heterogeneous interaction between molecules, wherein kᵢⱼ is a correction term of the attractive force between molecules, β is a correction term of the degree of coming from a standard state to a state under high temperature and high pressure, and lᵢⱼ is a correction term that shows the state of a substance (in the case of a pure substance, it is obtained from the eccentric coefficient). As mentioned above, if the values of kᵢⱼ, lᵢⱼ and β are determined, the physical properties of a mixture can be calculated by using the constants (T_{c}, P_{c} and ω) of a pure substance.

In the case when gas-liquid equilibrium is calculated, the thermodynamic condition for phase equilibrium in a gas-liquid system is that the fugacities of the respective components in both phases are equal under constant temperature and pressure.

The fugacity of the component i in the liquid phase fᵢ=the fugacity of the component i in the gas phase fᵢ

In this formula, f represents a fugacity.

[ii] Procedures for Calculating Calculated Value Kc of Gas-Liquid Equilibrium Constant

The equilibrium constant Kc can be obtained by, for example, the following procedures in a two-component system including components i and j.

[ii-1] First, mutual parameters between heterogeneous molecules are determined. It is necessary to determine parameters kᵢⱼ, lᵢⱼ and β that show heterogeneous interaction between molecules from gas-liquid equilibrium data.

Meanwhile, as mentioned below, in the case when kᵢⱼ and β can be readily determined from collective data or the like but lᵢⱼ cannot be determined unambiguously, lᵢⱼ can be determined by implementing a trial-and-error calculation in which a calculation is implemented by using assumptive values, and investigating the adequacy of the calculated value Kc of the gas-liquid equilibrium constant that is obtained when the fugacity of the component in the liquid phase and the fugacity of the component in the liquid phase are equal by using the actually measured value Km of the gas-liquid equilibrium constant.

[ii-2] a, aᵢⱼ, b and bᵢⱼ are obtained respectively by applying the above-mentioned parameters showing heterogeneous interaction between molecules to the exponent-type mixing rule or the like.

a and aᵢⱼ can be obtained by assigning kᵢⱼ and the like to the above-mentioned formula (4) and the like.

b and bᵢⱼ can be obtained by assigning lᵢⱼ, β and the like to the above-mentioned formula (5) and the like.

[ii-3] The respective fugacities of the gas phase and liquid phase are obtained from the SRK equation of state in the following formula (6).

$$\begin{matrix}[ Mathematical Formula 3 ] & \\ ln ( {f}_{i} / {x}_{i} P ) = \frac{1}{RT} {\int }_{V}^{∞} \{ {( \frac{\partial P}{\partial {n}_{i}} )}_{T , V , i \neq j} - \frac{RT}{V} \} d V - ln ( \frac{Pv}{RT} ) & ( 6 )\end{matrix}$$

Capital V: volume of phase
Uncapitalized v: molar volume of phase
n: molar number

Specifically, by applying the mixing rule (exponent-type mixing rule) to the above-mentioned formula, the respective fugacities fᵢ of the gas phase and liquid phase can be obtained from the following formula (7) that is described as the formula (22) on page 41 of Non-patent Literature 1.

$$\begin{matrix} [ Mathematical Formula 4 ] & \\ ln ( \frac{{f}_{i}}{{x}_{i} P} ) = - ln [ \frac{P ( v - b )}{RT} ] + \frac{{b}_{i}}{b} [ \frac{b}{v - b} - \frac{1}{RT} \frac{a}{v + b} ] - \frac{1}{RT} \frac{a}{b} ( \frac{2 {\sum }_{j} {x}_{j} {a}_{ij}}{a} - \frac{{b}_{i}}{b} ) ln ( \frac{v + b}{v} ) & ( 7 )\end{matrix}$$

Meanwhile, in the case of a pure substance, the fugacities of the gas phase and liquid phase can be obtained from the following formula (8) that is described as the formula (24) on page 41 of Non-patent Literature 1.

$$\begin{matrix}[ Mathematical Formula 5 ] & \\ ln ( \frac{f}{P} ) = \frac{Pv}{RT} - 1 - ln \frac{P ( v - b )}{RT} - \frac{a}{bRT} ln \frac{v + b}{v} & ( 8 )\end{matrix}$$

The condition of gas-liquid equilibrium is that the following four formulas are established for the temperature of the liquid phase part (Tₗ) and the temperature of the gas phase part (Tᵥ), the pressure of the liquid phase (Pₗ) and the pressure of the gas phase (Pᵥ), the fugacity of the liquid phase (fᵢ) and the fugacity of the gas phase (fᵢ) for the component i, and the fugacity of the liquid phase (fⱼ) and the fugacity of the gas phase (fⱼ) for the component j, respectively. Meanwhile, in the following formulas, T and P are described for showing that T and P are the same values in the liquid phase and gas phase, respectively, in the formulas (6) to (8).

Tₗ=Tᵥ=T

Pₗ═Pᵥ=P

For the component i, the fugacity of the liquid phase (fᵢ)=the fugacity of the gas phase (fᵢ)

For the component j, the fugacity of the liquid phase (fⱼ)=the fugacity of the gas phase (fⱼ)

Furthermore, since the composition of the gas and liquid phases has the relationships for the components i and j by the definition:

the concentration of the component i (xᵢ)+the concentration of the component j (xⱼ) in the liquid phase=1, and

the concentration of the component i (xᵢ)+the concentration of the component j (xⱼ) in the gas phase=1, the gas-liquid equilibrium constant Kc can be obtained, for example, for the component j, from [the concentration of the component j in the liquid phase (xⱼ)]/[the concentration of the component j in the gas phase (xᵢ)], from the above-mentioned equations.

[ii-4] In the case when the calculated value Kc of the gas-liquid equilibrium constant is not equal, as compared to the actually measured value Km,

the assumptive value of lᵢⱼ is changed, and the gas-liquid equilibrium calculation is implemented repetitively until the calculated value Kc of the gas-liquid equilibrium constant becomes equal to the actually measured value Km.

When the calculated value Kc becomes equal to the actually measured value Km, the above-mentioned assumptive value can be used as gas-liquid equilibrium data in the two-component system consisting of the components i and j.

As mentioned above, although it is necessary to obtain once the actually measured value Km of the gas-liquid equilibrium constant in the two-component system consisting of the components i and j, once “l₁₂” at which the calculated value Kc of the gas-liquid equilibrium constant becomes equal to the actually measured value Kc is obtained from the above-mentioned trial-and-error calculation, thereafter each “l₁₂” can be used for the calculation of the gas-liquid equilibrium constant in the same mixing system, and thus it is not necessary to obtain “l₁₂” on a case-by-case basis.

Meanwhile, in a system that does not form an azeotropic composition, the impurity component concentration in the liquid phase (Clₙ) can be estimated from the impurity component concentration in the gas phase (Cvₙ) by utilizing the calculated value Kc or actually measured value Km of the gas-liquid equilibrium constant as mentioned above. Furthermore, also in a system that forms an azeotropic composition, the impurity component concentration in the liquid phase (Clₙ) can be estimated from the impurity component concentration in the gas phase (Cvₙ) by utilizing the ratio of the liquid phase concentration and the gas phase concentration of each impurity component (Iₙ) in the liquefied gas that is held in a gas-liquid equilibrium state at a constant temperature (t° C.), similarly to the system that does not form an azeotropic composition.

[iii] Application of Equation of State and Mixing Rule

In the above, the exponent-type mixing rule was applied as a mixing rule to the SRK equation of state for obtaining the calculated value Kc of the gas-liquid equilibrium constant; however, as mentioned above, a simplified mixing rule (for example, see the following Non-patent Literature 6) may be applied as a mixing rule to the SRK equation of state, and the PSRK mixing rule (for example, see the following Non-patent Literature 7) may be used for the SRK equation of state as a mixing rule, and furthermore, the equation of state is not limited to the SRK equation of state and the BWR equation of state (for example, see the following Non-patent Literature 5) or the like can also be used.
(a) Non-patent Literature 5 (a literature about the BWR equation of state)

Hiroshi Takamatsu and Yasuyuki Ikegami, “The reports of Institute of Advanced Material Study, Interdisciplinary Graduate School of Engineering Sciences, Kyushu University”, Vol. 4, No. 1, 1990, p. 23-37
(b) Non-patent Literature 6 (a literature about the simplified mixing rule)

Kenji Mishima and other five persons, Fukuoka University Review of Technological Science, Vol. 59, 1997, p. 125-129
(c) Non-patent Literature 7 (a literature about the PSRK equation of state)

Shoji Haruki and Hidenori Azuma, Science and Technology of High Pressure, Vol. 16, 2006, p. 260

### (1-3) Example of Means for Obtaining Actually Measured Value Km and Calculated Value Kc of Gas-Liquid Equilibrium Constant of Ammonia-Methane System

An example of a means for obtaining an actually measured value Km and a calculated value Kc of a gas-liquid equilibrium constant when methane is included in liquefied ammonia as an impurity component is shown below.

### (1-3-1) Example of Means for Obtaining Actually Measured Value Km of Gas-Liquid Equilibrium Constant

Samples 1-1 to 9 shown in Table 1 having different concentrations of methane included in liquefied ammonia were each supplied to a container, and the methane concentration in the gas phase and the methane concentration in the liquid phase in the container were measured in a state maintained at 25° C. and 0.898 MPa.

When the sample from the gas phase part in the above-mentioned container is collected, the temperature of the circumstance for collection was adjusted to an atmosphere at a temperature equal to or more than the temperature of the above-mentioned container, and the collection was implemented under a condition in which a part of the collected sample is not liquefied. The same applied to the temperature of the circumstance for measurement.

The methane concentration in the sample collected from the gas phase part was measured by a gas chromatograph GC-PDD (format: a gas chromatograph with a pulse discharge detector, manufactured by GL Science).

Furthermore, the methane concentration in the liquid phase was measured. A sample was collected from the liquid phase in the above-mentioned each container, and the liquid phase was vaporized and homogenized in a vaporizer, and the measurement was implemented by using the above-mentioned GC-PDD.

The measured values of the methane concentration in the above-mentioned gas phase and the methane concentration in the liquid phase are collectively shown in Table 1.

The results of obtaining the measurement value of the gas-liquid equilibrium constant Km (the methane concentration in the liquid phase/the methane concentration in the gas phase) for each of Samples 1-1 to 9 are shown in Table 1. The measurement values Km for the respective samples were all approximately 0.003, and the average value thereof was 0.0031.

TABLE 1

| | Methane | Methane | Gas-liquid- |
|---|---|---|---|
| | concentration | concentration | equilibrium |
| | in gas phase | in liquid phase | constant Km |
| | [Actually | [Actually | [Actually |
| | measured value] | measured value] | measured value] |
| Sample No. | (vol. ppb) | (vol. ppb) | — |
| Sample 1-1 | 2203 | 7 | 0.003177 |
| Sample 1-2 | 2600 | 8 | 0.003077 |
| Sample 1-3 | 3554 | 11 | 0.003095 |
| Sample 1-4 | 4662 | 14 | 0.003003 |
| Sample 1-5 | 5612 | 17 | 0.003029 |
| Sample 1-6 | 11000 | 33 | 0.003000 |
| Sample 1-7 | 14093 | 43 | 0.003051 |
| Sample 1-8 | 18741 | 59 | 0.003148 |
| Sample 1-9 | 74318 | 244 | 0.003283 |
| | | | (Average |
| | | | value 0.0031) |

### (1-3-2) Example of Means for Obtaining Calculated Value Kc of Gas-Liquid Equilibrium Constant

This is a calculation example at 25° C. and 0.898 MPa of a mixed system composed of an ammonia-methane system.

The subscript “1” represents ammonia, and the subscript “2” represents methane.

### [i] Ammonia

Known gas-liquid equilibrium data for ammonia is described below.

### T_{c1}=132.5° C.

### P_{c1}=11.33 MPa

ω₁=0.25
α₁=1.26
[ii] Methane

Known gas-liquid equilibrium data for methane is described below.

### T_{c2}=−82.4° C.

### P_{c2}=4.63 MPa

ω₂=0.008
α₂=1.77
[iii] Parameters for Heterogeneous Interaction Between Molecules k₁₂, l₁₂ and β
k₁₂: since the attractive force that affects between ammonia-methane is very small, k₁₂=0.
β: β=1, which is a value for β that can be applied within a range in which under a high temperature and a high pressure is not assumed.
l₁₂: this was calculated by setting the assumptive values as follows, l₁₂=0 and l₁₂=−0.6, respectively.
[iv] Calculation of Fugacity of Liquid Phase f₂ and Fugacity of Gas Phase f₂

Specifically, they were determined by the following procedures from the methane concentration of 74,000 vol·ppb in the ammonia gas phase (this correspond to the case when the methane concentration in ammonia is relatively high) when the methane concentration in the ammonia liquid phase was 240 vol·ppb.

<1> In case when l₁₂ is assumed to be 0
<1-1> Assuming that l₁₂=0, the fugacity of the liquid phase f₂ and the fugacity of the gas phase f₂ were calculated from the above-mentioned formula (7).
<1-2> The methane concentration in the liquid phase and the methane concentration in the gas phase when the fugacity of the liquid phase f₂=the fugacity of the gas phase f₂ were calculated.
<1-3> The calculated value Kc and actually measured value Km (0.0032=240/74,000) of the gas-liquid equilibrium constant obtained from the methane concentration in the liquid phase and the methane concentration in the gas phase that are obtained by the calculation of the above-mentioned <1-2> are compared and evaluated.
<1-4> As a result of the above-mentioned <1-3>, since the calculated value Kc lost touch with the actually measured value Km, the following recalculation was implemented.
<2> In case when l₁₂ is assumed to be −0.6
<2-1> Assuming that l₁₂=−0.6, a calculation was implemented by the above-mentioned formula (7) in a similar manner to that described in the above-mentioned <1>.
2-2> The calculated value Kc and actually measured value Km (0.0032) of the gas-liquid equilibrium constant obtained from the methane concentration in the liquid phase and the methane concentration in the gas phase, which were obtained by the calculation, were approximately the same value.
<3> Since the parameters of heterogeneous interaction between molecules k₁₂, l₁₂ and β were determined in such manner, the gas-liquid equilibrium constant and the like of the ammonia-methane system can be obtained afterward by using these gas-liquid equilibrium data.

### (1-3-3) Correspondence of Actually Measured Value Km and Calculated Value Kc of Gas-Liquid Equilibrium Constant

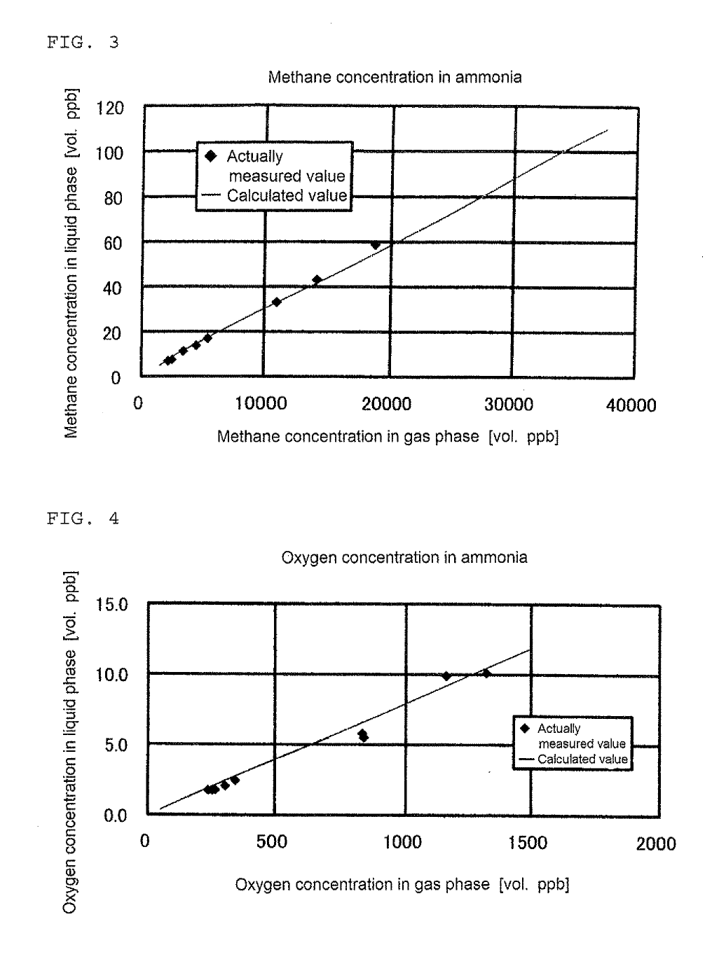

FIG. 3 shows the actually measured values of the concentrations of methane in the ammonia liquid phase and in the gas phase in Table 1 by plotting. From the slope of a virtual line obtained by connecting the plots, the actually measured value Km of the gas-liquid equilibrium constant (0.0031) is obtained.

Furthermore, FIG. 3 shows the calculated value Kc of the gas-liquid equilibrium constant ([240/74000]=0.0032) obtained by the above-mentioned calculation from the SRK equation of state and exponent-type mixing rule by a solid line.

It could be ascertained that the actually measured value Km and the calculated value Kc from the theoretical formula in FIG. 3 is in a fine correspondence relationship, and that it is effective to obtain the gas-liquid equilibrium constant by a theoretical calculation.

From the above, the methane concentration in the liquid phase can be estimated from the methane concentration in the gas phase (measured value) and the actually measured value Km or calculated value Kc of the gas-liquid equilibrium constant.

### (1-4) Example of Means for Obtaining Actually Measured Value Km and Calculated Value Kc of Gas-Liquid Equilibrium Constant in Ammonia-Oxygen System

### (1-4-1) Example of Means for Obtaining Actually Measured Value Km of Gas-Liquid Equilibrium Constant

Similarly to the case of the above-mentioned ammonia-methane system, Samples 2-1 to 9 shown in Table 2 having different concentrations of oxygen included in liquefied ammonia were each supplied to a container, and the oxygen concentration in the gas phase and the oxygen concentration in the liquid phase in the container were measured by GC-PDD in a state maintained at 25° C. and 0.898 Mpa. The measurement values thereof are collectively shown in Table 2.

For each of Samples 2-1 to 9, the actually measured value Km of the gas-liquid equilibrium constant (the oxygen concentration in the liquid phase/the oxygen concentration in the gas phase) was obtained. The results are shown in Table 2. The actually measured values Km of the gas-liquid equilibrium constants of the respective samples were all approximately 0.007, and the average value thereof was 0.0072.

TABLE 2

| | Oxygen | Oxygen | Gas-liquid- |
|---|---|---|---|
| | concentration | concentration | equilibrium |
| | in gas phase | in liquid phase | constant Km |
| | [Actually | [Actually | [Actually |
| | measured value] | measured value] | measured value] |
| Sample No. | (vol. ppb) | (vol. ppb) | — |
| Sample 2-1 | 244 | 1.8 | 0.007377 |
| Sample 2-2 | 261 | 1.8 | 0.006897 |
| Sample 2-3 | 275 | 1.8 | 0.006545 |
| Sample 2-4 | 311 | 2.1 | 0.006752 |
| Sample 2-5 | 352 | 2.5 | 0.007102 |
| Sample 2-6 | 838 | 5.5 | 0.006563 |
| Sample 2-7 | 830 | 5.8 | 0.006988 |
| Sample 2-8 | 1162 | 9.9 | 0.008520 |
| Sample 2-9 | 1324 | 10.1 | 0.007628 |
| | | | (Average |
| | | | value 0.0072) |

### (1-4-2) Example of Means for Obtaining Calculated Value Kc of Gas-Liquid Equilibrium Constant

A calculation example in the case when liquefied ammonia including oxygen as an impurity component is maintained at 25° C. and 0.898 Mpa in a container.

The subscript “1” represents ammonia, and the subscript “2” represents oxygen.

### [1] Ammonia

Known gas-liquid equilibrium data for ammonia is described below.

### T_{c1}=132.5° C.

### P_{c1}=11.33 MPa

ω₁=0.25
α₁=1.26
[ii] Oxygen

Known gas-liquid equilibrium data for oxygen is described below.

### T_{c2}=−118.57° C.

### P_{c2}=5.05 MPa

ω₂=0.292
α₂=1.77
[iii] Parameters for Heterogeneous Interaction Between Molecules k₁₂, l₁₂ and β
k₁₂: since the attractive force that affect between ammonia-oxygen is very small, k₁₂=0.
β: β=1, which is a value for β that can be applied within a range in which under a high temperature and a high pressure is not assumed.
l₁₂: this was calculated by setting the assumptive values as follows, l₁₂=0 and l₁₂=−1.1, respectively.

Specifically, they were determined by the following procedures from the oxygen concentration 10 vol·ppb in the ammonia gas phase (this correspond to the case when the oxygen concentration in ammonia is relatively high) when the oxygen concentration in the ammonia liquid phase was 1300 vol·ppb.

<1> In case when l₁₂ is assumed to be 0
<1-1> Assuming that l₁₂=0, the fugacity of the liquid phase f₂ and the fugacity of the gas phase f₂ were calculated from the above-mentioned formula (7).
<1-2> The methane concentration in the liquid phase and the methane concentration in the gas phase when the fugacity of the liquid phase f₂=the fugacity of the gas phase f₂ were calculated.
<1-3> The calculated value Kc and actually measured value Km (0.0077=10/1,300) of the gas-liquid equilibrium constant obtained by the methane concentration in the liquid phase and the methane concentration in the gas phase obtained by the calculation of the above-mentioned <1-2> are compared and evaluated.
<1-4> As a result of the above-mentioned <1-3>, since the calculated value Kc lost touch with the actually measured value Km, the following recalculation was implemented.
<2> In case when l₁₂ is assumed to be −1.1
<2-1> Assuming that l₁₂=−1.1, a calculation was implemented by the above-mentioned formula (7) in a similar manner to that described in the above-mentioned <1>.
<2-2> The calculated value Kc (0.0077) and actually measured value Km (0.0072) of the gas-liquid equilibrium constant obtained from the methane concentration in the liquid phase and the methane concentration in the gas phase, which were obtained by the calculation, were approximately the same value.
<3> Since the parameters of heterogeneous interaction between molecules k₁₂, l₁₂ and p were determined in such manner, the gas-liquid equilibrium constant and the like of the ammonia-oxygen system can be obtained afterward by using these gas-liquid equilibrium data.

### (1-4-3) Correspondence of Actually Measured Value Km and Calculated Value Kc of Gas-Liquid Equilibrium Constant

FIG. 4 shows the actually measured values of the concentrations of oxygen in the ammonia liquid phase and in the gas phase of Table 2 by plotting. From the slope of a virtual line obtained by connecting the plots, the actually measured value Km of the gas-liquid equilibrium constant (0.0072) is obtained.

Furthermore, FIG. 4 shows the calculated value Kc of the gas-liquid equilibrium constant ([10/1300]=0.0076) obtained by the above-mentioned calculation from the SRK equation of state and exponent-type mixing rule by a solid line.

It could be ascertained that the actually measured value Km and the calculated value Kc from the theoretical formula in FIG. 4 is in a fine correspondence relationship, and that it was effective to obtain the gas-liquid equilibrium constant by a theoretical calculation.

From the above, the oxygen concentration in the liquid phase can be estimated from the oxygen concentration in the gas phase (measurement value) and the actually measured value Km or calculated value Kc of the gas-liquid equilibrium constant.

(2) Estimation of Amount of Gas to be Discharged (W) from Impurity Component Concentrations (Cvₙ and Clₙ)

Each impurity component concentration in the liquid phase (Clₙ) can be estimated from each impurity component concentration in the gas phase (Cvₙ) and the gas-liquid equilibrium constant (Kₙ) in the above-mentioned container, and the amount of the gas to be discharged (W) of the liquefied gas vaporized from the gas phase part in the refinement tank can be estimated so as to obtain the objective refined liquefied gas.

It is desirable to obtain the amounts of the gas to be discharged (W) that are respectively necessary for the respective impurity component concentrations (Cv₁₋ₙ and Cl₁₋ₙ) and adopt the amount to be discharged to each impurity component having the largest amount to be discharged among these amounts to be discharged.

As the estimation of the amount to be discharged (W), it is possible to estimate the amount of the gas to be discharged (W) for discharging the raw material liquefied gas (R) from the gas phase part, by calculating the evaporation of each impurity component (Iₙ) from the hold amounts and the impurity component concentrations (C_{R}vₙ and C_{R}lₙ) in the liquid phase part and gas phase part of the liquefied gas in the refinement tank. Meanwhile, in the case when the hold amount of the gas phase part is small and can be neglected in practical use, the amount of the gas to be discharged (W) can also be estimated by a calculation from the hold amount and the impurity component concentration (Clₙ) of the liquid phase part of the liquefied gas in the refinement tank.

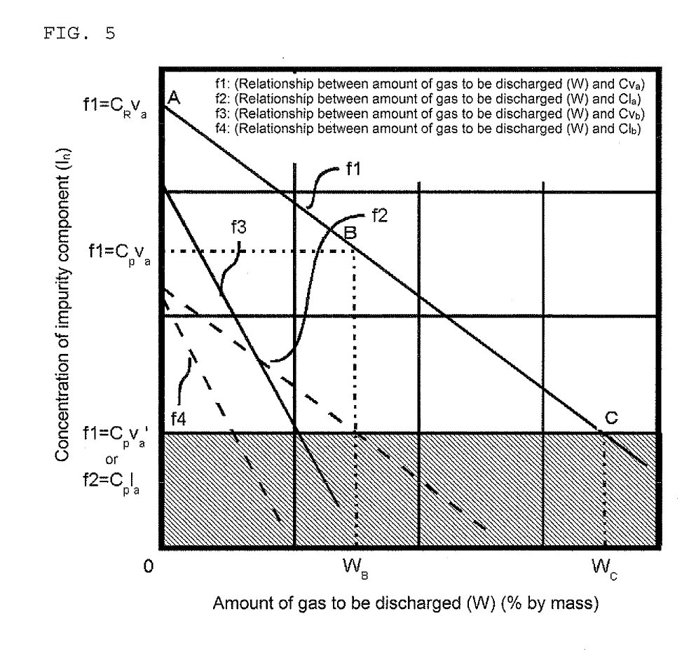

Alternatively, although the amount of the gas to be discharged (W) can also be obtained by calculation, if the relationships of the amount of the gas to be discharged (W) and the impurity component concentrations (Cv₁₋ₙ and Cl₁₋ₙ) as shown in the following FIG. 5 are obtained by actual measurements in advance by transferring the raw material liquefied gas to be refined (R) to the refinement tank in advance, and discharging the gas while maintaining an approximate gas-liquid equilibrium state at the above-mentioned temperature at which the gas is discharged and suitably analyzing the impurity component concentrations in the gas to be discharged (Cv₁₋ₙ), the raw material liquefied gas (R) can be refined afterward by using the actually measured values when a similar raw material liquefied gas (R) is to be refined by using the refinement tank.

FIG. 5 is an explanatory drawing that shows the method for estimating the amount of the gas to be discharged (W) when the liquefied gas in the liquid phase is refined by discharging the gas from the gas phase part of the liquefied gas in the refinement tank based on the actually measured values. The vertical axis in FIG. 5 is a logarithm axis and shows the impurity component concentration.

For example, in FIG. 5, when the raw material liquefied gas (R) including an impurity component a is stored at a constant temperature in the refinement tank, the relationship between the amount of the gas to be discharged (% by mass) against the amount of the liquefied gas in the liquid phase and the impurity component concentration in the gas phase (Cvₐ) in which the gas phase and liquid phase are held in an equilibrium state is shown by the line of f1 from measured values or empirical values or the like. f1 varies in an exponential fashion irrespective of the shape of the refinement tank, and the like.

On the other hand, the relationship between the impurity concentration (Cvₐ) and the impurity concentration in the liquid phase (Clₐ) that is obtained from the gas-liquid equilibrium constant Kₐ is shown by the line of f2. f2 varies in an exponential fashion irrespective of the shape of the refinement tank, and the like.

When the concentration of the liquid phase impurity component a of the liquefied gas in the refinement tank is equal to or less than the concentration represented by the point C in FIG. 5 (C_{P}lₐ or less), the amount of the gas to be discharged may be W_{B} or more, and the concentration of the impurity component a in the gas phase at this time is C_{P}vₐ or less.

Furthermore, when the concentration of the gas phase impurity component a of the liquefied gas in the refinement tank is equal to or less than the concentration represented by the point C in FIG. 5 (C_{P}vₐ′ or less), the amount of the gas to be discharged may be W_{c} or more.

Similarly, in FIG. 5, the raw material liquefied gas (R) including impurity component b is stored at a constant temperature, and the relationship between the amount of the gas to be discharged (% by mass) with respect to the amount of the liquefied gas in the liquid phase and the impurity component concentration in the gas phase (Cv_{b}) that is held in a gas-liquid equilibrium state is represented by the line f3 from the measured values or empirical values, or the like. On the other hand, the relationship between the impurity concentration (Cv_{b}) and the impurity concentration in the liquid phase (Cl_{b}) obtained from the gas-liquid equilibrium constant K_{b} is represented by the line f4. In this case, when the concentration of the impurity component b in the liquid phase or gas phase is desired to be equal to or less than the concentration represented by the point C in FIG. 5, it can be considered in a manner similar to the case that the above-mentioned impurity component a is included. Furthermore, f3 and f4 vary in an exponential fashion irrespective of the shape of the refinement tank, and the like.

As mentioned above, if a drawing in which the respective impurity component concentrations in the liquid phase and gas phase corresponding to the amount of the gas to be discharged (% by mass) have been measured or estimated is prepared in advance, it is possible to readily estimate the amount of the gas to be discharged (% by mass) for refinement by measuring each impurity component concentration in the gas phase of the raw material liquefied gas (R) in the refinement tank. Furthermore, if the impurity component concentration in the gas phase of the refined liquefied gas (P) that is stored at a constant temperature after the refinement and held in a gas-liquid equilibrium state is measured, the impurity component concentration in the liquid phase can be estimated, whereby the impurity component concentration in the refined liquefied gas can be controlled readily.

### [4-2] Operation 2

Operation 2 is an operation comprising refining the liquefied gas in the liquid phase by removing the highly volatile impurity component (Iₙ) that has concentrated in the gas phase and the impurity component (Iₙ) that comes from the liquid phase to the gas phase and concentrates therein by vaporizing the liquefied gas, by discharging continuously or intermittently the above-mentioned amount of the gas to be discharged (W) from the gas phase part in the refinement tank.

In FIGS. 1 and 2, the vaporized liquefied gas is discharged from the discharge passage 3. In this case, the discharging can be implemented continuously or intermittently, and the discharging is desirably implemented under a condition of a constant flow amount. The destination for the discharging can be treated with removal equipments such as a burning furnace, an absorption tower, an adsorption column and the like, or supplying can be implemented from the supply passage 2 to a receiver that can also be used for a low purity liquefied gas.

Since the discharge amount of the liquefied gas vaporized from the refinement tank can be known from measurement of the weight of the refinement tank, an integrated value of the mass flow controller that is disposed on the discharge passage, or the analysis value of the impurity concentration (Cvₙ) of the gas chromatograph that is disposed on the discharge passage or supply passage, the amount to be discharged can be readily controlled by setting the amount to be discharged in advance by using a process control system or the like in advance.

Furthermore, in Operation 2, the aperture of the controller can be controlled by providing feedback of a detection signal of the impurity concentration in the gas phase part (C_{R}vₙ) that has been measured by the gas chromatograph (16) to the mass flow controller (22) that is disposed on the discharge passage.

Meanwhile, as the vaporization of the liquefied gas proceeds in the refinement tank, the temperature of the liquefied gas in the liquid phase tends to decrease since evaporation latent heat is taken away, the highly volatile impurity component can be concentrated more in the gas phase by avoiding rapid decrease in temperature and by maintaining a state close to equilibrium between the liquid phase and gas phase; therefore, in order to keep the inside of the refinement tank at a constant temperature, a means such as disposing the refinement tank in a thermostatic bath having temperature regulating function, disposing a jacket having temperature regulating function on the circumference area of the refinement tank, implementing discharging intermittently to restore an equilibrium state, or the like can be adopted. Among these means, it is preferable to dispose the refinement tank in the above-mentioned thermostatic bath. In this case, as shown in FIG. 1, the heating of the heater can be controlled by a signal from the pressure gauge (25) by disposing the heater (43) on the thermostatic bath (41) in advance.

Meanwhile, although the preferable volumes, surface areas on the liquid surface and the like of the respective gas phase part and liquid phase part in the refinement tank cannot be necessarily determined from the kinds of the liquefied gas and the impurity component (Iₙ), the concentration of the highly volatile impurity component (Iₙ) included in the liquefied gas, the gas-liquid equilibrium constant (Kₙ), and the like, it is desirable to consider the volumes, surface areas on the liquid surface and the like of the respective gas phase part and liquid phase part in the refinement tank so that the discharging of the gas from the gas phase part in the container can be implemented smoothly and the impurity component (Iₙ) can be removed efficiently.

### [4-3] Operation 3

Operation 3 is an operation comprising ascertaining the quality of the refined liquefied gas by estimating the impurity component concentration in the liquid phase (Clₙ) from the impurity component concentration (Cvₙ) in the gas phase that has been collected from the gas phase part, discharge passage or supply passage in the refinement tank that is kept at a constant temperature (t° C.) or constant pressure (pPa) and held in a gas-liquid equilibrium state in the above-mentioned gas discharging step, immediately before completion of the discharging, or after completion of the discharging, and the gas-liquid equilibrium constant (Kₙ). Although not depicted FIGS. 1 and 2, it is desirable that a temperature detection part and a sample collection part are disposed in the refinement tank (13 or 34).

The operation for estimating the impurity component concentration in the liquid phase from the impurity component concentration in the sample collected from the gas phase part in the refinement tank (the impurity component concentration in the gas phase) and the gas-liquid equilibrium constant (Kₙ) is similar to those described in Operation 1.

### [4-4] Operation 4

Operation 4 is an operation comprising ascertaining the quality of the above-mentioned refined liquefied gas (P), followed by supplying the refined liquefied gas from the refinement tank to the receiver. After the predetermined discharging of the gas is implemented in Operation 2 and the product purity of the liquefied gas in the refinement tank is ascertained in Operation 3, the liquefied gas is supplied from the supply passage 1 or supply passage 2 to the receiver.

As shown in FIG. 1, during supplying liquefied gas from the supply passage 1 or supply passage 2 to the receiver, the opening and closing of the gas phase ejection valve (31), the liquid phase ejection valve (32) and the like can also be controlled by signals from the weight scale (42), the impurity component concentration (Cvₙ) that has been measured by the gas chromatograph (16) disposed on the supply passage 2, and the like.

In the case when the refined liquefied gas (P) is supplied from the supply passage 1 to the receiver as shown in FIG. 1 or 2, the pressure reducing valve (23), the vaporizer (14), the moisture removing tube (15 or 38), the mass flow controller (24) and the like can be disposed on the supply passage 1, and furthermore, a metal removing filter (not depicted) can also be disposed on the latter stage of the moisture removing tube (15 or 38), and the like.

Furthermore, in the case when the refined liquefied gas (P) is supplied from the supply passage 1 to the receiver as shown in FIG. 1 or 2, an oil component removing apparatus (35), the pressure reducing valve (23), the vaporizer (14), the moisture removing tube (15 or 38), the mass flow controller (24) and the like can be disposed, and furthermore, a metal removing filter (not depicted) can also be disposed on the latter stage of the moisture removing tube (15 or 38), and the like.

As the oil component removing apparatus (35), an apparatus in which active carbon or the like is filled therein can be used as in the above-mentioned oil component removing apparatus (12); as the pressure reducing valve (23), a known one can be used; indirect heating using a heating medium, an electrothermal heater or the like can be adopted as a heating source to the vaporizer (14); a dehydrating agent such as known zeolite and silica gel can be used for the moisture removing tube (15 or 38); and as the mass flow controller (24), known one can be used.

Meanwhile, some dehydrating agents can sufficiently adsorb and remove particulate metal impurities besides moisture by that the dehydrating agents act as a filtering material; however, if filtering at higher purity is necessary, supplying can be implemented by disposing a metal removing filter on the latter stage of the moisture removing tube. As the metal removing filter, for example, a commercially available hollow yarn filter, a sintered filter or the like may be used.

### EXAMPLES

Next, the present invention is explained in more detail by Examples. However, the present invention is not limited to these Examples.

### Example 1

In Example 1, using the refinement tank (13) of the type as shown in the flow drawing in FIG. 1, the relationship between the amount of the gas to be discharged and decrease in the impurity concentration in the gas phase and the impurity concentration in the liquid phase when implementing refining of raw material liquefied ammonia as shown in FIG. 5 was obtained.

The concentration of the impurity methane included in the gas phase component in the refinement tank (13) was measured by a gas chromatograph GC-PDD (format: a gas chromatograph with a pulse discharge detector, manufactured by GL Science), and the concentration of the impurity methane included in the liquid phase component was measured by collecting the sample from the liquid phase, vaporizing the sample by a vaporizer and homogenizing, and using the above-mentioned gas chromatograph.

### (1) Refining Apparatus

The inner volume of the refinement tank (13) is 20 liter (inner diameter 220 mm, height 525 mm).

As shown in FIG. 1, the refining apparatus is connected by pipes so that the liquefied gas can be filled in the refinement tank (13) from the storage container (11) through the oil component removing apparatus (12); the gas chromatograph (16) for measuring the concentration of the impurity component included in the gas phase component is connected to the discharge passage 3; the moisture removing tube (15) in which an adsorbent that can remove moisture is filled is connected to the supply passage 1 through the pressure reducing valve (23) and vaporizer (14); and the moisture scale (17) (a cavity ringdown spectroscopy (CRDS)-type moisture scale) is connected to the supply passage 1 so that the amounts of moisture before and after the moisture removing tube can be measured. Active carbon is filled in the oil component removing apparatus as an oil component removing agent, and molecular sieve is filled in the moisture removing apparatus.

### (2) Refining Operations

### (2-1) Operation 1

16 liter of raw material liquefied ammonia (10 Kg) that corresponded to 80% of the volume of the refinement tank was transferred to and filled in the refinement tank (13) from the storage container (11) shown in FIG. 1 through the oil component removing apparatus (12).

After the transfer, the liquefied ammonia was stood still for 1 or more hours, and the impurity components included in the gas phase component in the refinement tank were measured from the discharge passage 3 under a state that the inside of the refinement tank was maintained at 25° C. and 0.898 Mpa, whereby the analysis result described in the left row column in Table 3 was obtained.

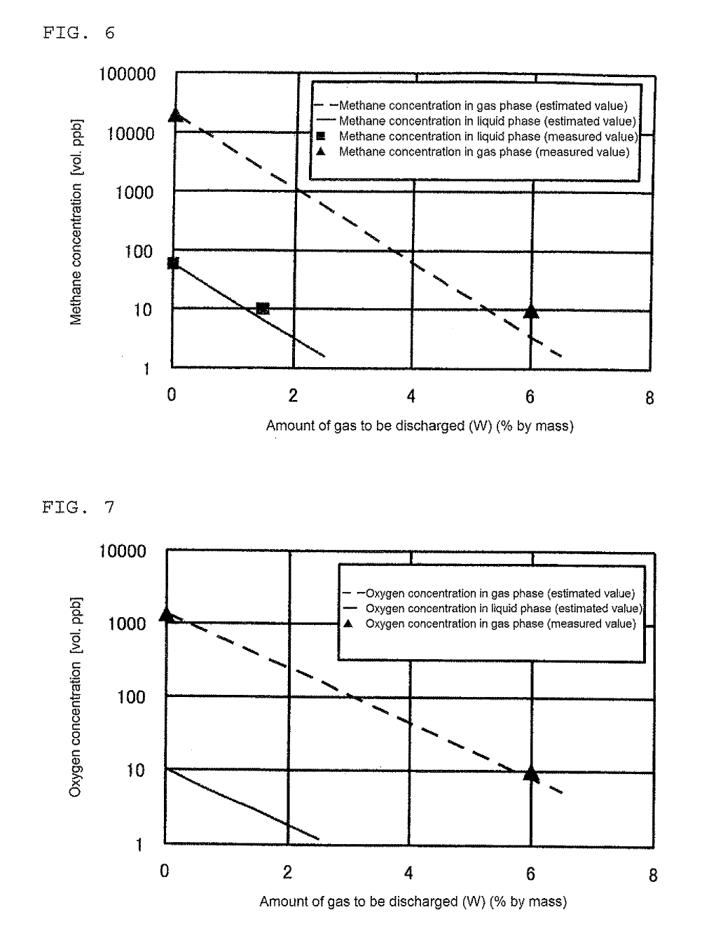

When the relationship between the amount of the gas to be discharged (W) and the impurity component concentration was calculated from the impurity concentration in the gas phase (Cvₙ) and the impurity concentration in the liquid phase (Clₙ) obtained from the Cvₙ, and the volumes of the gas phase part and liquid phase part, the methane concentrations in the gas phase and liquid phase shown in FIG. 6, and the estimated values of the oxygen concentrations in the gas phase and liquid phase shown in FIG. 7 (which are shown by broken lines and solid lines in FIGS. 6 and 7, respectively) were obtained.

From the respective concentrations and the amounts of the gas to be discharged for methane and oxygen, which are shown in FIGS. 6 and 7, respectively, it was estimated that it is necessary to discharge a gas amount of 600 g that corresponds to 6% by mass of the filling amount so as to adjust the ammonia purity to 99.999 (vol. %) or more.

### (2-2) Operations 2 and 3

600 g, which corresponds to 6% by mass of the filling amount, was discharged from a gas phase exhaust port attached to the refinement tank to the discharge passage 3 by a flow amount of 10 slm (standard liter/min.) over about 80 minutes while maintaining the inside of the refinement tank at about 25° C. When the discharging was completed, the impurity components (which correspond to the impurity components included in the gas phase of the refinement tank) were detected at the discharge passage, whereby liquefied ammonia from which highly volatile impurity components had been removed was obtained as shown in the right row column in Table 3.

Next, by the above-mentioned discharging operation, the liquid phase of the refined liquefied gas was supplied from the liquid phase ejection valve (32) attached to the refinement tank to the vaporizer (14) through the pressure reducing valve (23). When the moisture included in the vaporized liquefied gas was measured, the moisture concentration at the side of the upper stream of the moisture removing tube (15) was 200 ppm, and the moisture concentration at the side of the downstream thereof was decreased to 10 vol·ppb that is the lower limit of quantification, or less. When the purity of the refined liquefied ammonia was measured by a gas chromatograph GC-PDD at the side of the downstream of the moisture removing tube (15), the refined liquefied ammonia had a purity of 99.999 (vol. %) or more.

FIG. 6 shows the measured values of the concentration of methane that is an impurity component in the liquid phase in the refinement tank and gas phase before the above-mentioned gas discharging, the methane concentration in the liquid phase at the time when 1.5% by mass of the gas was discharged, and the methane concentration in the gas phase in the refinement tank at the completion of discharging of the gas.

Furthermore, FIG. 7 shows the concentration of oxygen that is an impurity component in the liquid phase in the refinement tank and gas phase before the above-mentioned discharging of the gas, and the concentration of the impurity oxygen in the liquid phase that was obtained from the oxygen concentration in the gas phase in the refinement tank at the completion of the gas discharging and the gas-liquid equilibrium constant.

TABLE 3
Example 1

| | Raw material liquefied ammonia | | | | Refined ammonia after gas discharge | | | |
|---|---|---|---|---|---|---|---|---|
| | Gas phase | | Liquid phase | | Gas phase | | Liquid phase | |
| | component | | component | | component | | component | |
| | concentration | | concentration | | concentration | | concentration | |
| | (measured value) | | (measured value) | | (estimated value) | | (estimated value) | |
| Ammonia | >99.9 | (vol. %) | | | >99.97 | (vol. %) | | |
| purity | | | | | | | | |
| Impurity | | | | | | | | |
| component | | | | | | | | |
| concentration | | | | | | | | |
| (1) Nitrogen | 800 | (vol. ppb) | <10 | (vol. ppb) | <10 | (vol. ppb) | <10 | (vol. ppb) |
| (2) Oxygen | 1300 | (vol. ppb) | <10 | (vol. ppb) | 10 | (vol. ppb) | <10 | (vol. ppb) |
| (3) Hydrogen | 300 | (vol. ppb) | <10 | (vol. ppb) | <10 | (vol. ppb) | <10 | (vol. ppb) |
| (4) Carbon | <10 | (vol. ppb) | <10 | (vol. ppb) | <10 | (vol. ppb) | <10 | (vol. ppb) |
| monoxide | | | | | | | | |
| (5) Methane | 20 | (vol. ppm) | 80 | (vol. ppb) | 10 | (vol. ppb) | <10 | (vol. ppb) |
| (6) Moisture | 15 | (vol. ppm) | 200 | (vol. ppm) | 15 | (vol. ppm) | 200 | (vol. ppm) |

* The moisture concentration at the outlet of the moisture removing tube was less than 10 (vol. ppb).
The ammonia purity at the outlet of the moisture removing tube was 99.999 (vol. %) or more.

From the result obtained in Example 1, in the case when refining is implemented by using raw material liquefied ammonia including highly volatile impurity components, which is approximately similar to that used in Example 1, if FIGS. 6 and 7 are used, it becomes possible to estimate an amount of the gas to be discharged that is necessary for refining of the raw material liquefied ammonia.

### Example 2

Liquefied ammonia was refined by transferring to and filling in the refinement tank raw material liquefied ammonia including highly volatile impurities in the liquefied ammonia at concentrations similar to those used in Example 1, and implementing gas discharging from the gas phase part.

### (1) Refining Apparatus

The inner volume of the refinement tank (13) is 20 liter (inner diameter 220 mm, height 525 mm).

As the refining apparatus, an apparatus similar to that used in Example 1 was used.

As shown in FIG. 1, pipes are connected so that the liquefied gas can be filled in the refinement tank (13) from the storage container (11) through the oil component removing apparatus (12); the gas chromatograph (16) for measuring the concentration of the impurity component included in the gas phase component is connected to the discharge passage 3; the moisture removing tube (15) in which an adsorbent that can remove moisture is filled is connected to the supply passage 1 through the pressure reducing valve (23) and vaporizer (14); and the moisture scale (17) (a cavity ringdown spectroscopy (CRDS)-type moisture scale) is connected to the supply passage 1 so that the amounts of moisture before and after the moisture removing tube can be measured. The weight scale (42) is disposed as a monitor of the residual amount of the liquefied gas in the refinement tank. The liquid phase receiving valve (26) is opened and closed upon receiving a signal that shows the residual amount from the weight scale. The gas phase ejection valve (31) and liquid phase ejection valve (32) are opened and closed upon receiving a monitor signal of the weight scale (42) of the refinement tank. The refinement tank (13) is disposed in the thermostatic bath (41) in which a heat medium and the like are stored, and the heater (43) that can control a temperature upon receiving a signal from the pressure gauge (25) is disposed on the thermostatic bath (41). Active carbon is filled in the oil component removing apparatus (12) as an oil component removing agent, and a molecular sieve is filled in the moisture removing tube (15).

### (2) Refining Operations

### (2-1) Operation 1

16 liter of raw material liquefied ammonia (10 Kg) that corresponded to 80% of the volume of the refinement tank was transferred to and filled in the refinement tank (13) from the storage container (11) through the oil component removing apparatus (12).

After the transfer, the liquefied ammonia was stood still for 1 or more hours, and the impurity components included in the gas phase component in the refinement tank were measured from the discharge passage 3 under a state that the inside of the refinement tank was maintained at 25° C. and 0.898 Mpa, whereby the analysis result described in the left row column in Table 4 was obtained.

When FIGS. 6 and 7, which show the relationship between the amount of the discharged gas and decrease in the impurity concentrations in the gas phase and the impurity concentrations in the liquid phase during refining of the raw material liquefied ammonia, which was obtained in the above-mentioned Example 1, are referred to, it was estimated that it is necessary to discharge the gas in an amount of 600 g that corresponds to 6% by mass of the filling amount so as to adjust the ammonia purity to 99.999 (vol. %) or more.

### (2-2) Operations 2 and 3

The gas was discharged from the gas phase ejection valve (31) attached to the refinement tank to the discharge passage 3 by a flow amount of 10 slm (standard liter/min.). During this time, the impurity concentration in the discharge passage were monitored by the gas chromatograph (16), and at the time when 600 g of the gas, which corresponds to 6% by mass of the filling amount, was discharged over about 80 minutes while the inside of the refinement tank was maintained at about 25° C., it was ascertained that a refined liquefied gas from which highly volatile impurity components had been removed was obtained as shown in the right row column in Table 4, whereby the gas phase ejection valve (31) was automatically closed by a signal from the gas chromatograph (16) and a signal for opening the liquid phase ejection valve (32) was sent.

### (2-3) Operation 4

Thereafter, supplying from the refinement tank (13) through the liquid phase ejection valve (32), pressure reducing valve (23) and vaporizer (14) was automatically initiated. When the concentration of the moisture included in the vaporized liquefied gas was measured, it could be ascertained that the moisture concentration at the side of the upper stream of the moisture removing tube (15) was 200 ppm, and the moisture concentration at the side of the downstream was decreased to 10 vol·ppb that is the lower limit of quantification, or less. When the purity of the refined liquefied ammonia was measured by a gas chromatograph GC-PDD at the side of the downstream of the moisture removing tube (15), the refined liquefied ammonia had a purity of 99.999 (vol. %) or more.

The liquefied gas was supplied continuously, the amount scale (42) detected that the residual amount of the liquefied gas in the refinement tank became 10% or less and the supplying was stopped automatically, and the transfer and filling of the raw material liquefied ammonia were initiated automatically from the storage container (11) through the liquid phase receiving valve (26).

At the time when the filling amount in the refinement tank became 10 kg, the liquid phase receiving valve (26) was closed by a signal from the amount scale (42), and the transfer and filling were stopped automatically. After the transfer, the inside of the refinement tank was maintained at about 25° C. and 0.898 M by standing still for about 1 hour. Thereafter discharging was initiated at a flow amount of 10 slm from the gas phase ejection valve (31) to the discharge passage 3 while the temperature was maintained at above temperature. At the time when 600 g of the gas that corresponded to 6% by mass of the filling amount was discharged over about 80 minutes, removal of the highly volatile impurities was ascertained as in after the above-mentioned discharging. The gas phase ejection valve (31) was closed, whereby the discharging from the gas phase part was stopped automatically. Thereafter, the raw material liquefied ammonia was transferred and filled again from the storage container (11) through the liquid phase receiving valve (26).

TABLE 4
Example 2

| | Raw material liquefied ammonia | | | | Refined ammonia after gas discharge | | | |
|---|---|---|---|---|---|---|---|---|
| | Gas phase | | Liquid phase | | Gas phase | | Liquid phase | |
| | component | | component | | component | | component | |
| | concentration | | concentration | | concentration | | concentration | |
| | (measured value) | | (measured value) | | (estimated value) | | (estimated value) | |
| Ammonia | >99.9 (vol. %) | | | | >99.97 (vol. %) | | | |
| purity | | | | | | | | |
| Impurity | | | | | | | | |
| component | | | | | | | | |
| concentration | | | | | | | | |
| (1) Nitrogen | 800 | (vol. ppb) | <10 | (vol. ppb) | <10 | (vol. ppb) | <10 | (vol. ppb) |
| (2) Oxygen | 1300 | (vol. ppb) | <10 | (vol. ppb) | 10 | (vol. ppb) | <10 | (vol. ppb) |
| (3) Hydrogen | 300 | (vol. ppb) | <10 | (vol. ppb) | <10 | (vol. ppb) | <10 | (vol. ppb) |
| (4) Carbon | <10 | (vol. ppb) | <10 | (vol. ppb) | <10 | (vol. ppb) | <10 | (vol. ppb) |
| monoxide | | | | | | | | |
| (5) Methane | 25 | (vol. ppm) | 80 | (vol. ppb) | 10 | (vol. ppb) | <10 | (vol. ppb) |
| (6) Moisture | 15 | (vol. ppm) | 200 | (vol. ppm) | 15 | (vol. ppm) | 200 | (vol. ppm) |

* The moisture concentration at the outlet of the moisture removing tube was less than 10 (vol. ppb).
The ammonia purity at the outlet of the moisture removing tube was 99.999 (vol. %) or more.

### Example 3

Liquefied ammonia was refined by transferring to and filling in the refinement tank raw material liquefied ammonia including highly volatile impurities in the liquefied ammonia at concentrations similar to those used in Example 1, and implementing gas discharging from the gas phase part.

### (1) Refining Apparatus

As a refining apparatus, a siphon tube type refinement tank (34) (inner volume: 100 liter, inner diameter: 350 mm, height: 1,000 mm) as shown in FIG. 2 was used.

In the refinement tank (34), raw material liquefied ammonia that is approximately similar to that used in Example 1 is stored in a state that it is maintained at 50 kg, 25° C. and 0.898 MPa.

The moisture removing tube (38) in which an adsorbent that can remove moisture is filled is connected to the refinement tank (34) from the liquid phase ejection valve (32) through the oil component removing apparatus (35), pressure reducing valve (36) and vaporizer (37). Furthermore, a CRDS type moisture scale (17) is connected to the transfer passage that leads to the supply passage 1 so that the amounts of moisture before and after the moisture removing tube can be measured. The gas chromatograph (16) is connected to the discharge passage 3 at the side of the downstream of the gas phase ejection valve (31) of the refinement tank (13).

### (2) Refining Operations

### (2-1) Operation 1

When the impurity components included in the gas phase component were measured by the gas chromatograph (16) disposed on the discharge passage 3 at a state that the inside of the refinement tank (34) was maintained at 25° C. and 0.898 MPa, the analysis results described in the left row column in Table 5 were obtained.

When FIGS. 6 and 7, which show the relationship between the amount of the discharged gas and decrease in the impurity concentration in the gas phase and the impurity concentration in the liquid phase during refining of the raw material liquefied ammonia, which were obtained in the above-mentioned Example 1, were referred to, it was estimated that it is necessary to discharge a gas amount of 3,000 g that corresponds to 6% by mass of the filling amount so as to adjust the ammonia purity to 99.999 (vol. %) or more.

### (2-2) Operations 2 and 3

3,000 g, which corresponds to 6% by mass of the filling amount, was discharged over approximately 400 minutes from the gas phase ejection valve (31) attached to the refinement tank to the discharge passage 3, while the inside of the refinement tank was maintained at about 25° C. and the flow amount was controlled to 10 slm (standard liter/min.) by the mass flow controller (33).

When the impurity components in the gas phase (which correspond to the impurity components included in the gas phase of the refinement tank) were detected at the discharge passage 3 after the discharging was completed, ammonia from which the highly volatile impurity components had been removed, which is shown in the right row column of Table 5, was obtained.

Next, the concentration of the moisture included in the liquefied ammonia that was obtained by vaporizing the liquid phase of the refined liquefied ammonia in the vaporizer (37) from the liquid phase ejection valve (32) through the oil component removing apparatus (35) and pressure reducing valve (36) was measured by the moisture scale (17), and found to be 200 ppm. Next, the concentration of the moisture included in the vaporized liquefied gas after removing the moisture in the moisture removing tube (38) was decreased to 10 vol·ppb that is the lower limit of quantification, or less. As a result of an analysis by the gas chromatograph (16) disposed at the side of the downstream of the moisture removing tube (38), the purity of the refined ammonia was 99.999 (vol. %) or more.

TABLE 5
Example 3

| | Raw material liquefied ammonia | | | | Refined ammonia after gas discharge | | | |
|---|---|---|---|---|---|---|---|---|
| | Gas phase | | Liquid phase | | Gas phase | | Liquid phase | |
| | component | | component | | component | | component | |
| | concentration | | concentration | | concentration | | concentration | |
| | (measured value) | | (measured value) | | (estimated value) | | (estimated value) | |
| Ammonia | >99.9 | (vol. %) | | | >99.97 | (vol. %) | | |
| purity | | | | | | | | |
| Impurity | | | | | | | | |
| component | | | | | | | | |
| concentration | | | | | | | | |
| (1) Nitrogen | 800 | (vol. ppb) | <10 | (vol. ppb) | <10 | (vol. ppb) | <10 | (vol. ppb) |
| (2) Oxygen | 1300 | (vol. ppb) | <10 | (vol. ppb) | <10 | (vol. ppb) | <10 | (vol. ppb) |
| (3) Hydrogen | 300 | (vol. ppb) | <10 | (vol. ppb) | <10 | (vol. ppb) | <10 | (vol. ppb) |
| (4) Carbon | <10 | (vol. ppb) | <10 | (vol. ppb) | <10 | (vol. ppb) | <10 | (vol. ppb) |
| monoxide | | | | | | | | |
| (5) Methane | 20 | (vol. ppm) | 66 | (vol. ppm) | <10 | (vol. ppb) | <10 | (vol. ppb) |
| (6) Moisture | 15 | (vol. ppm) | 200 | (vol. ppm) | 15 | (vol. ppm) | 200 | (vol. ppm) |

* The moisture concentration at the outlet of the moisture removing tube was less than 10 (vol. ppb).
The ammonia purity at the outlet of the moisture removing tube was 99.999 (vol. %) or more.

### INDUSTRIAL APPLICABILITY

According to the method for supplying a refined liquefied gas of the present invention, a semiconductor material gas can be supplied at a high purity to a semiconductor-manufacturing apparatus, and products formed by the semiconductor-manufacturing apparatus have higher quality.

### DESCRIPTION OF REFERENCE NUMERALS

11 Storage container
12 Oil component removing apparatus
13 Refinement tank
14 Vaporizer
15 Moisture removing tube
16 Gas chromatograph
17 Moisture scale
21 Liquid phase ejection valve
22 Mass flow controller
23 Pressure reducing valve
24 Mass flow controller
26 Liquid phase receiving valve
31 Gas phase ejection valve
32 Liquid phase ejection valve
33 Mass flow controller
34 Refinement tank
35 Oil component removing apparatus
36 Pressure reducing valve
37 Vaporizer
38 Moisture removing tube
39 Mass flow controller
41 Thermostatic bath
42 Weight scale
43 Heater

1. A method for supplying a refined liquefied gas, comprising
refining a raw material liquefied gas (R) that is stored in a refinement tank, or a raw material liquefied gas (R) that has been transferred from a storage container to the refinement tank, which comprises one or more impurity component(s) (Iₙ) having higher volatility than that of a liquefied gas that is a main component, by gas discharging from a gas phase part in the refinement tank, and supplying the refined liquefied gas (P) to a receiver, by implementing at least the following Operations 1 to 4:
<1> an operation (Operation 1) comprising collecting a sample from the gas phase part in the refinement tank in which the raw material liquefied gas (R) is kept at a constant temperature (t° C.) or constant pressure (pPa) and held in a gas-liquid equilibrium state, and measuring the concentration (C_{R}vₙ) of each impurity component (Iₙ) in the gas phase part, followed by estimating each impurity component concentration in the liquid phase (C_{R}lₙ) in the refinement tank from the obtained each concentration (C_{R}vₙ) and the ratio between the liquid-phase concentration and the gas-phase concentration of each impurity component (gas-liquid equilibrium constant (Kₙ)) of each component at the constant temperature (t° C.) or constant pressure (pPa), according to the following formula (1), and
estimating the amount of the gas to be discharged (W) from the gas phase part in the refinement tank required for refining the raw material liquefied gas (R), by removing the highly volatile impurity component (Iₙ) that has concentrated in the gas phase part in the refinement tank and the impurity component (Iₙ) that comes from the liquid phase to the gas phase and concentrates therein when the liquefied gas in the liquid phase is vaporized in the refinement tank, from the respective concentrations ((C_{R}vₙ) and (C_{R}lₙ)) and the hold amounts of the impurity component in the gas phase and liquid phase,
Impurity component concentration in liquid phase (C_{R}lₙ)=Kₙ×impurity component concentration in gas phase (C_{R}vₙ) (1),
<2> an operation (Operation 2) comprising refining the liquefied gas in the liquid phase by removing the highly volatile impurity component (Iₙ) that has concentrated in the gas phase part and the impurity component (Iₙ) that comes from the liquid phase to the gas phase and concentrates therein by vaporizing the liquefied gas, by discharging continuously or intermittently the amount of the gas to be discharged (W) from the gas phase part in the refinement tank to a discharge passage,
<3> an operation (Operation 3) comprising measuring the concentration of each impurity component (Iₙ) of the sample collected from the gas phase part in the refinement tank that is kept at a constant temperature (t° C.) or constant pressure (pPa) and held in a gas-liquid equilibrium state in the discharging step, and/or after completion of the discharging, followed by estimating the concentration of the impurity component in the liquid phase (C_{P}lₙ) from the obtained each concentration (C_{P}vₙ) and the gas-liquid equilibrium constant (Kₙ), whereby ascertaining the quality of the refined liquefied gas (P), and
<4> an operation (Operation 4) comprising ascertaining the quality of the refined liquefied gas (P), followed by supplying the refined liquefied gas (P) from the refinement tank to the receiver through a supply passage.

2. The method for supplying a refined liquefied gas according to claim 1, wherein
the Operation 2 comprises providing feedback of a detection signal of the impurity concentration in the gas phase part (C_{R}vₙ) measured by a gas chromatograph to a mass flow controller that is disposed on the discharge passage to control the aperture of the controller, or
the Operation 4 comprises providing feedback of a detection signal of the impurity concentration in the gas phase part (C_{P}vₙ) measured by a weight scale in the refinement tank or a gas chromatograph to a mass flow controller that is disposed on the supply passage to control the aperture of the controller.

3. The method for supplying a refined liquefied gas according to claim 1, wherein the transfer of the raw material liquefied gas (R) from the storage container to the refinement tank in the Operation 1 is transfer of the raw material liquefied gas from which oil components have been removed to the refinement tank through an oil component separating apparatus.

4. The method for supplying a refined liquefied gas according to claim 1, wherein the Operation 4 is an operation for supplying the refined liquefied gas (P) from the liquid phase part in the refinement tank to the receiver through a pressure reducing valve, a vaporizer and a moisture removing tube.

5. The method for supplying a refined liquefied gas according to claim 1, wherein the Operation 4 is an operation for supplying the refined liquefied gas (P) from the liquid phase part in the refinement tank to the receiver through a pressure reducing valve, a vaporizer, a moisture removing tube and a metal removing filter.

6. The method for supplying a refined liquefied gas according to claim 1, wherein the Operation 4 is an operation for supplying the refined liquefied gas (P) from the liquid phase part in the refinement tank to the receiver through an oil component separating apparatus, a pressure reducing valve, a vaporizer and a moisture removing tube.

7. The method for supplying a refined liquefied gas according to claim 1, wherein the Operation 4 is an operation for supplying the refined liquefied gas (P) from the liquid phase part in the refinement tank to the receiver through an oil component separating apparatus, a pressure reducing valve, a vaporizer, a moisture removing tube and a metal removing filter.

8. The method for supplying a refined liquefied gas according to claim 1, wherein the gas-liquid equilibrium constant (Kₙ) is an actually measured value Km that is obtained by collecting samples respectively from the liquid phase and the gas phase part that are held in a gas-liquid equilibrium state in the refinement tank in which the liquefied gas is stored at a constant temperature (t° C.) and performing quantitative analysis, or a calculated value Kc that is obtained from the Soave-Redlich-Kwong equation of state (SRK equation of state) and an exponent-type mixing rule that show the relationship between the amount of the impurity component included in the gas phase and the amount of the impurity component included in the liquid phase at a constant temperature (t° C.), from the physical property values including the critical temperature, critical pressure and polarizability of the impurity component.

9. The method for supplying a refined liquefied gas according to claim 1, wherein the liquefied gas is liquefied ammonia, and the impurity component(s) in the liquid phase is/are at least methane and/or oxygen.
